(19) United States
(12) Patent Application Publication
(10) Pub. No.: US 2009/0002276 A1
(43) Pub. Date: Jan. 1, 2009

(54) METHOD OF DRIVING PLASMA DISPLAY PANEL

(75) Inventor: Yoshito TANAKA, Chou-shi (JP)

Correspondence Address: SUGHRUE MION, PLLC, 2100 PENNSYLVANIA AVENUE, N.W., SUITE 800, WASHINGTON, DC, 20037, US

(73) Assignee: Pioneer Corporation, Tokyo (JP)

(21) Appl. No.: 12/125,690

(22) Filed: May 22, 2008

(30) Foreign Application Priority Data
Jun. 27, 2007 (JP) 2007-168920

(51) Int. Cl. G09G 3/28

(52) U.S. Cl. 345/60

(57) ABSTRACT

A plasma display panel driving method permitting to improve dark contrast without causing erroneous discharge. A forced address discharge is executed with respect to a discharge cell positioned adjacent to said one discharge cell, in each of the discharge cells belonging to a display line to be addressed immediately before a display line, to which belongs at least one discharge cell to effect the address discharge in accordance with an input video signal (pixel drive data).

### BACKGROUND OF THE INVENTION

1. Field of the Invention

The present invention relates to a method of driving a plasma display panel according to an input video signal.

2. Description of the Related Art

Recently, as a large-screen thin display device, a plasma display apparatus is commercialized, which is equipped with a plasma display panel (hereinafter called “PDP”) in which discharge cells corresponding to pixels are arranged in a matrix form.

Moreover, a PDP is proposed which is designed to enhance the discharge probability by incorporating a vapor-phase magnesium oxide which make CL light emission having a peak at 200-300 nm by electron irradiation, in a magnesium oxide layer placed to coat the electrode in each discharge cell. For example, refer to Japanese Patent Kokai No. 2006-54160 (Patent Document 1). In such PDP, discharge delay is reduced to a great degree, which makes it possible to generate weak current stably in a short period of time. In this event, it is possible improve a contrast when dark image is displayed, that is, so-called “dark contrast”.

However, because there is a reset discharge generated simultaneously in all discharge cells to initialize the discharge cell state, as a discharge regardless of display image. Because of this, it has been impossible to improve the dark contrast to a great extent.

### SUMMARY OF THE INVENTION

Therefore, a method of driving a PDP without generating a reset discharge has been proposed. For example, refer to Japanese Patent Kokai No. 2001-312244 (Patent Document 2).

However, there arises a problem that, when the reset discharge is not generated, various types of the succeeding discharges are not generated in a stable manner, with increased possibility of generating erroneous discharge.

The present invention is made to solve such a problem, and has an object of providing a method of driving a plasma display panel which can improve the dark contrast without generating an erroneous discharge.

The driving method of a plasma display panel according to a first aspect of the present invention is a driving method of a plasma display panel in which a plurality of discharge cells serving as pixels are arranged in each of a plurality of display lines, and are driven for graduation display, in correspondence to each of a plurality of sub-fields comprising each field of an input video signal. Each of said sub-fields comprises an address stage where said display lines are addressed sequentially line by line, and each of the discharge cells belonging to the addressed display line is set to either of light emitting mode or non-light emitting mode by selectively effecting an address discharge in the discharge cell according to pixel drive data, and a sustain stage where a sustain discharge is effected only the discharge cells set to said light emitting mode repeatedly in a frequency corresponding to a luminance weight of said sub-field. The pixel drive data indicates whether or not discharge is to be effected in each of said discharge cells, and is generated based on said input video signal. In said address stage of a predetermined subfield in each of the said sub-fields, immediately before a display line to which belongs at least one display cell to effect the address discharge according to said pixel drive data, the address discharge is forcibly effected in a discharge cell positioned adjacent to said one discharge cell among discharge cells belonging to a display line immediately before said display line to which the at least one display cell belongs.

In each of the discharge cells belonging to a display line immediately before the display line to which at least one discharge cell to effect address discharge according to an input video signal (pixel drive data) belongs, the forced discharge is effected in the discharge cell positioned adjacent to said one discharge cell.

Thereby, when generating address discharge for said one discharge cell, address discharge is necessarily generated immediately theretofore, even in the discharge cells positioned adjacent thereto. Therefore, with such address discharge forcibly generated, electrically-charged particles are obtained in an amount required for discharge immediately thereafter, and address discharge is generated securely in said one discharge cell. Thereby, without resort to reset discharge, the electrically-charged particles can be obtained in an amount required for discharge, and the discharge cells can be driven without erroneous discharge so as to improve the dark contrast, even if reset discharge is weak or omitted.

### BRIEF DESCRIPTION OF THE DRAWINGS

FIG. 1 is a diagram schematically showing the configuration of a plasma display apparatus which drives a plasma display panel according to a driving method of the present invention;

FIG. 2 is a front view schematically showing an internal configuration of PDP50, viewed from a display side;

FIG. 3 is a diagram showing a section on a line III-III, shown in FIG. 2;

FIG. 4 is a diagram showing a section on a line IV-IV;

FIG. 5 is a diagram showing an example of light emission patterns at multiple levels, in the plasma display apparatus shown in FIG. 1;

FIG. 6 is a diagram showing an example of light emission driving sequence which is used in the plasma display apparatus shown in FIG. 1;

FIG. 7 is a diagram showing an example of an internal configuration of a forced lighting circuit;

FIG. 8 is a diagram showing an example of a first bit in a pixel driving data GD which corresponds to each of discharge cells PC_{1,1}-PC_{9,1} arranged in a first column, and of a first bit in a pixel driving data GGD;

FIG. 9 is a diagram showing an example of an operation by forced lighting processing at a selective write addressing stage W_{W} for sub-fields SF1-SF3;

FIG. 10 is a diagram showing other driving patterns by forced lighting processing;

FIG. 11 is a diagram showing an example of forced lighting processing in a case of time-distributed write addressing operation in discharge cells belonging to an even-numbered display line, and a discharge cell belonging to an odd-numbered display line;

FIG. 12 is a diagram showing an internal configuration of the forced lighting processing circuit 3, in order to perform the forced lighting processing shown in FIG. 11;

FIG. 13 is a diagram showing an internal configuration of the forced lighting processing circuit 3 which is used to perform the forced lighting processing limitedly only when any sustain discharge is not performed during a period of displaying a preceding one field;

FIG. 14 is a diagram showing other configuration of a plasma display apparatus which drives a plasma display panel according to a method of driving plasma display apparatus other than that shown in FIG. 1;

FIG. 15 is a diagram showing an example of light emission patterns at multiple levels, in the plasma display apparatus shown in FIG. 14;

FIG. 16 is a diagram showing an example of a light emission driving sequence which is used in the plasma display apparatus shown in FIG. 14.

FIG. 17 is a diagram showing different driving pulses applied to PDP50, according the light emission driving sequence shown in FIG. 16;

FIG. 18 is a diagram showing an internal configuration of a forced lighting processing circuit 30; and

FIG. 19 is a diagram showing an example of by forced lighting processing at the selective write address stage Ww of a sub-field SF1.

### DETAILED DESCRIPTION OF THE INVENTION

Embodiments of the present invention will be described in detail with reference to the accompanying drawings.

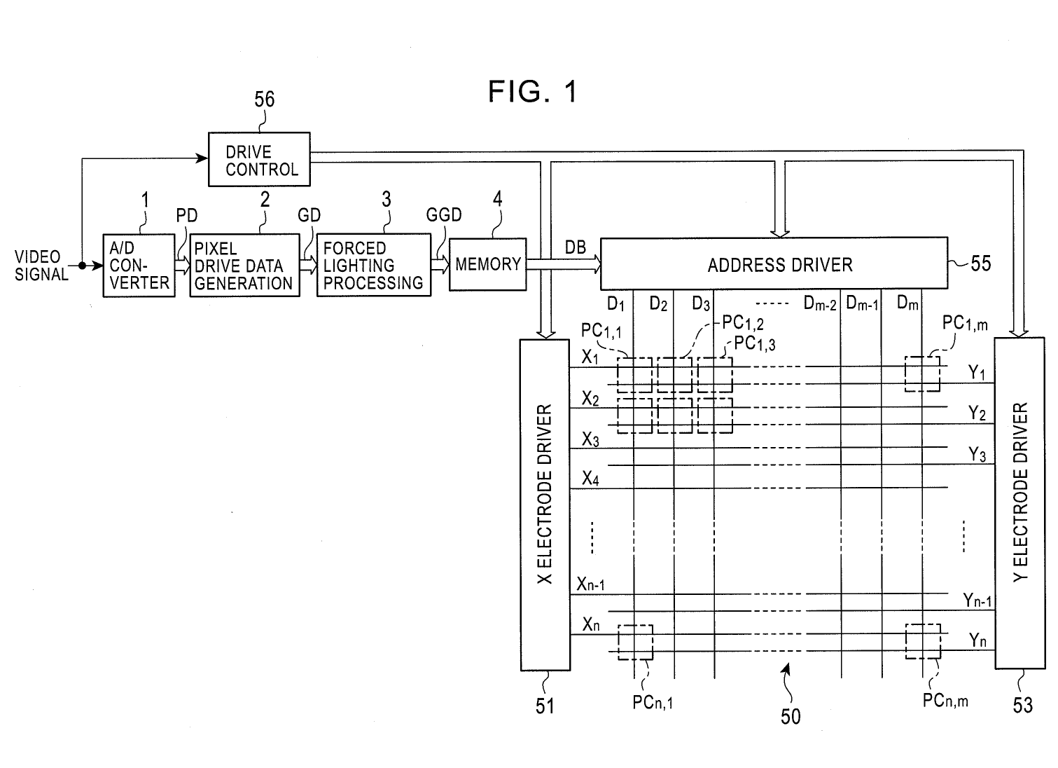

FIG. 1 is a diagram showing a schematic configuration of a plasma display apparatus according to the present invention.

As shown in FIG. 1, such plasma display panel apparatus is comprised of an A/D converter 1, a pixel drive data generator circuit 2, a forced lighting processing circuit 3, a memory 4, a PDP 50, a X electrode driver 51, a Y electrode driver 53, an address driver 55, and a driving control circuit 56.

In the PDP 50 as a plasma display panel, formed are column electrodes D₁-Dₘ, which are respectively extended and arranged in a longitudinal direction (vertical direction), and row electrodes X₁-Xₙ and row electrodes Y₁-Yₙ which are respectively extended and arranged in a latitudinal direction (horizontal direction). In this event, the row electrodes (Y₁, X₁), (Y₂, X₂), (Y₃, X₃) . . . , (Yₙ, Xₙ) which form a pair of the electrodes adjacent to each other, are respectively the first display lines to the n-th display line. At intersections between each of the display lines and each of the column electrodes D1-Dm (an area surrounded with alternate long and short dash lines in FIG. 1), formed are discharge cells (display cells) corresponding to pixels. In other words, In the PDP 50, arranged respectively in the form of matrix are discharge cells PC_{1,1}-PC₁,m, which belong to the first display line, and discharge cells PC_{n,1}-PC_{n,m} which belong to the n-th display line.

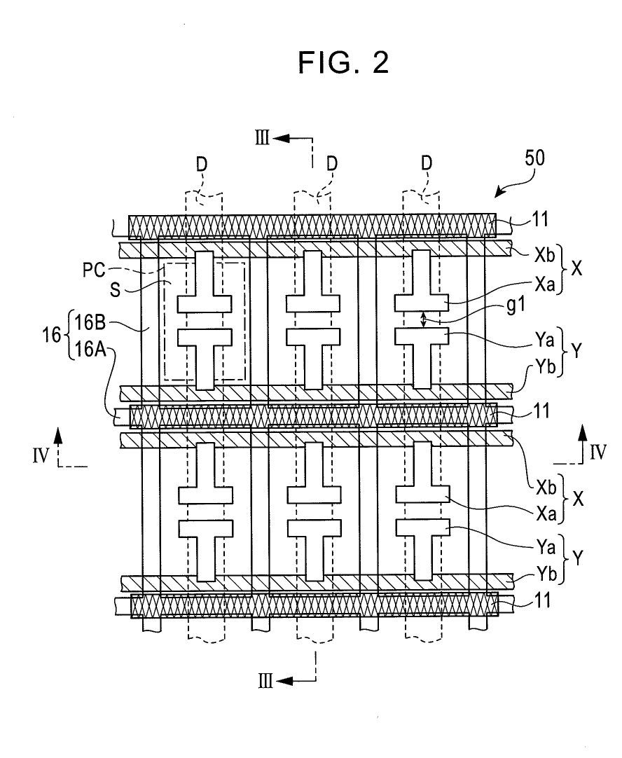

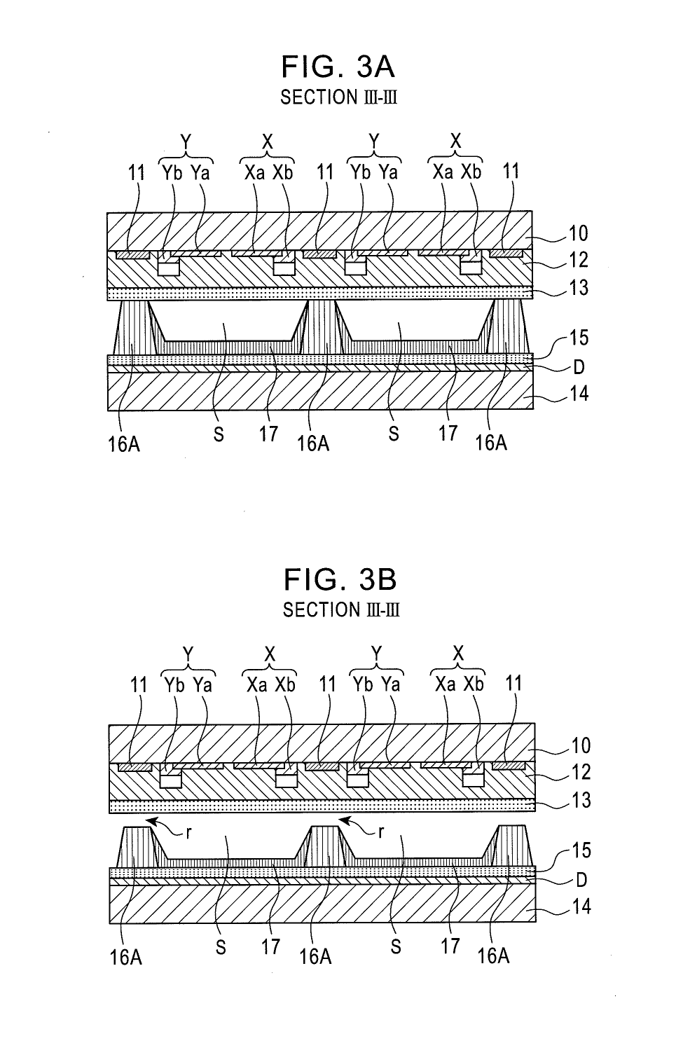

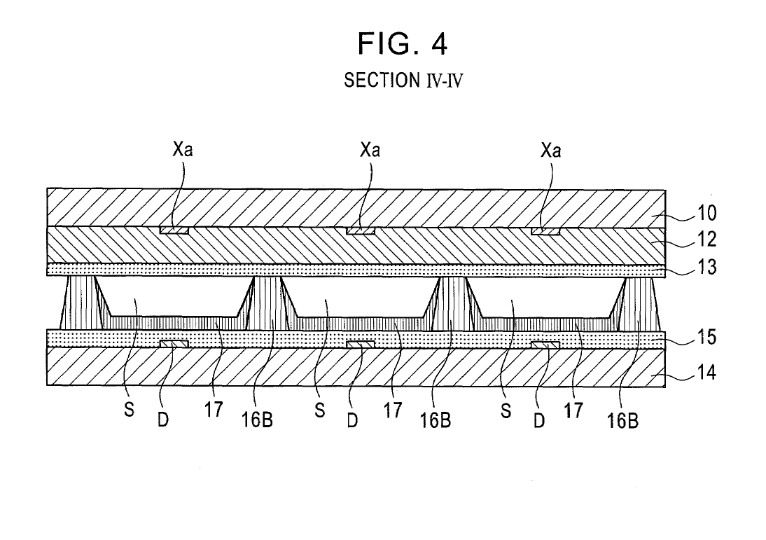

FIG. 2 is a front view showing the internal configuration of the PDP 50 viewed from the front side. In addition, FIG. 2 shows, as an extract, each of the intersections between the three column electrodes respectively adjacent to each another, and the two display lines adjacent to each other. Furthermore, FIG. 3 is a diagram showing the cross section of the PDP 50 on the line III-III in FIG. 2. FIG. 4 is a diagram showing the cross section on the line IV-IV in FIG. 2.

As shown in FIG. 2, each of the row electrodes X is comprised of a bus electrode extended horizontally on a two-dimensional display screen, and of a T-shaped transparent electrode which is set in contact at each of positions corresponding to each of the discharge cells PC on said bus electrode Xb. Each of the row electrodes Y is comprised of a bus electrode Yb extended horizontally on a two-dimensional display screen, and of a T-shaped transparent electrode Ya which is set in contact at each of positions corresponding to each of the discharge cells PC on said bus electrode Yb. The transparent electrodes Xa and Ya, for example, are comprised of a transparent conducting layer such as ITO and the like, and the bus electrodes Xb and Yb are comprised, for example, of a metal film. The row electrode comprised of the transparent electrode Xa and the bus electrode X, and the row electrode Y comprised of the transparent electrode Ya and the bus electrode Yb, are formed on the back side of the front-side transparent plate 10, of which front side is the display side of the PDP 50, as shown in FIG. 3 (a). In this event, the transparent electrodes Xa and Ya are extended toward the row electrodes which form a pair for each other on the opposite side, and at the larger side thereof, the top side faces each other with a discharge gap g1 of a predetermined width. Hereinafter, a combination of the row electrodes X and Y, which belong to the transparent electrodes Xa and Ya to form the electrode gap, is called a row electrode pair (X, Y). On the back side of the front-side transparent plate 10, between the row electrode pair (X, Y) and a row electrode pair adjacent to the aforementioned row electrode pair (X, Y), formed is a black or dark-colored light absorption layer (light shielding layer) 11, which is extended horizontally on the two-dimensional display screen. Furthermore, on the back side of the front-side transparent plate 10, a dielectric layer 12 is formed in such a manner as to cover the row electrode pair (X, Y). On the surface of the dielectric layer, the magnesium oxide layer 13 is formed. Specifically, the magnesium oxide layer 13 contains a crystalline body as a secondary electron emitting material for CL (cathode luminescence) which has a peak wavelength equal to or less than 200-300 nm or less, in particular, 230-250 nm or less after excitation by electron irradiation (hereinafter called “CL light emission MgO crystalline body). The CL light emission MgO crystalline body is obtained by submitting to vapor-phase oxidation, magnesium vapor generated by heating magnesium, and has, for example, a multiple crystalline structure in which cubes are fitted to each other, or a single crystalline structure of cubes. The average particle size of the CL light emission MgO crystalline body is 2000 Angstroms or more (measurement result by BET method).

When forming a vapor-phase method magnesium oxide single crystalline body having an average particle size of 2000 Angstroms or more, it is necessary to keep a heating temperature high when generating magnesium vapor. Because of this, a flame generated by reaction of magnesium with oxygen becomes long, and the temperature difference thereof to the environment becomes greater. As a result, the larger the vapor-phase method magnesium oxide single crystalline body has a larger particle size, the more often it becomes with an energy level corresponding to the aforementioned CL light emission peak wavelength (for example, around 235 nm, 230-250 nm or less). In addition, the vapor-phase method magnesium oxide single crystalline body has an energy level corresponding to the aforementioned CL light emission peak wavelength, when it is generated by increasing the volume of magnesium to vaporize per hour to enlarge the area of reaction with oxygen to increase reaction with oxygen, in comparison with the common vapor-phase oxidation method.

By applying such CL light emission MgO crystalline body to the surface of the dielectric layer 12, by the spray method or the like, the magnesium oxide layer is formed. In this case, on the surface of the dielectric layer 12, may be formed by vapor deposition or by spatter method a thin-film magnesium oxide layer, on which a CL light emission MgO crystalline body is applied to form the magnesium oxide layer 13.

On the other hand, on the back-side plate 14 arranged parallel to the front-side transparent plate 10, each of the row electrodes D is extended and formed in a direction orthogonal to the row electrode pair (X, Y) at a position opposite to the transparent electrodes Xa and Ya in each of the row electrode pairs. On the back-side plate 14, further, a white row electrode protection layer 15 for covering the row electrode D is formed. On the row electrode protection layer 15, formed is a partition wall comprised of a lateral wall 16A and a vertical wall 16B. The lateral wall 16A is respectively extended and formed in a lateral direction on the two-dimensional display screen, at positions between the row electrode pair (X, Y) adjacent to each other. On the other hand, the vertical wall 16B is extended and formed in a longitudinal direction on the two-dimensional display screen at positions between the row electrodes D adjacent to each other. In this case, in an area surrounded by the lateral wall 16A and the vertical wall 16B, set is a discharge cell PC including a discharge space S, the transparent electrodes Xa and Ya, which are respectively an independent space. In the discharge space S, discharge gases including xenon gas are sealed. Here, between the lateral wall 16A and the surface of the magnesium oxide layer 13, formed there is a small interstice, through which mutual connection is made between discharge spaces of the discharge cell PC adjacent to each other in a longitudinal direction on the two-dimensional display screen. This interstice is formed due to dispersion in height, respectively of the lateral wall 16A and the vertical wall 16B in manufacturing, and to subtle irregularity of shapes on the surface of the magnesium oxide layer 13. Specifically, as shown in FIG. 3 (b), by using the lateral wall 16A which is smaller in height by a predetermined length than the vertical wall 16B, through the interstice r, mutual connection may be made between the discharge spaces between the discharge cell PC adjacent to each other in a longitudinal direction on the two-dimensional display screen. Furthermore, the partition wall may be formed with only the vertical wall 16B, without the lateral wall 16A.

On the lateral side of the lateral wall 16A, the lateral side of the vertical wall 16B, and the surface of the row electrode protection layer 15 in each of the discharge cells PC, to cover all of the foregoing, formed is a fluorescent material layer 17. This fluorescent material layer 17 is, in fact, comprised of three fluorescent materials: a fluorescent material emitting a red color, a fluorescent material emitting a green color, and a fluorescent material emitting a blue color. For example, respectively formed are a red color emitting fluorescent material for the fluorescent material layer 17 of each of the discharge cells PC belonging to the (3K−2)th row electrodes (D₁, D₄, D₇, D₁₀ . . . ), a green color emitting fluorescent material for the fluorescent material layer 17 of each of the discharge cells PC belonging to the (3K−2)th row electrodes (D₂, D₅, D₈, D₁₁ . . . ), and a blue color emitting fluorescent material of the fluorescent material layer 17 for each of the discharge cells PC belonging to the (3K)th row electrodes (D₃, D₆, D₉, D₁₂ . . . ). That is, on one row electrode D, discharge cells emitting one of the red, green and blue colors are arranged. In addition, in the fluorescent material layer 17, a MgO crystalline body (including a CL light emission crystalline body) is contained as a secondary electron emitting material, and part thereof is exposed from the fluorescent material layer 17, so that it will be in contact with discharge gas, on a surface covering the discharge space on the surface of the fluorescent material layer 17, i.e., on a surface in contact with the discharge space S. In this manner, in the PDP 50, by using a configuration which includes a CL light emission MgO crystalline body in both magnesium oxide layer 13 and fluorescent material layer 17, discharge delay time is greatly reduced, and the degree of discharge becomes small, compared with the conventional PDP.

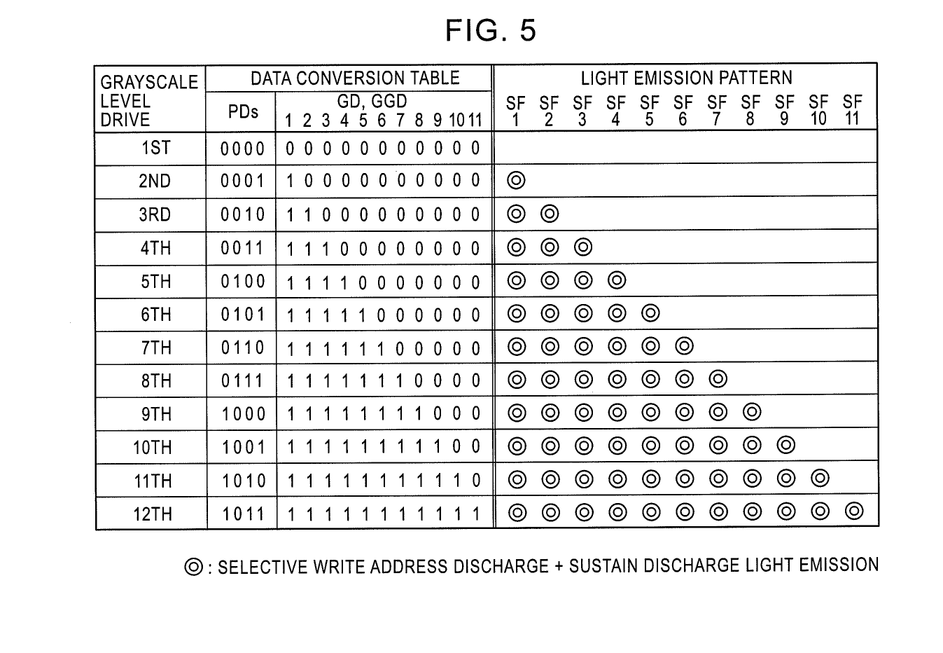

The A/D converter 1 samples an input video signal, converts it into pixel data PD, for example, of 8 bits, corresponding to each of the pixels, and supplies the pixel data PD to the pixel drive data generator circuit 2. The pixel drive data generator circuit 2 first performs a multiple grayscale processing comprised of error diffusion processing and dither processing for each of the pixel data PD for each pixel. For example, in the error diffusion processing, the pixel drive data generator circuit 2 has pixel data equivalent to high-order six bits as display data, and the remaining low order two bits as error data, and reflects data which is obtained by weighting addition of the error data in the pixel data corresponding to each of adjacent pixels on the aforementioned display data, to obtain six-bit error diffusion processing pixel data. By such error diffusion processing, luminance equivalent to low order two bits in original pixels is expressed by the adjacent pixels in a pseudo way. Accordingly, with the display data equivalent to six bits, which is less than eight bits, luminance grayscale representation can be made such as that with the pixel data equivalent 8 bits. Further, the pixel drive data generator circuit 2 submits to the dither processing, the 6-bit error diffusion pixel data obtained by the error diffusion processing. In the dither processing, a plurality of pixels adjacent to each other is one pixel unit. To each of said error diffusion processing pixel data which corresponds to each pixel in one unit pixel, dither coefficients comprised of coefficient values different with each other are allocated respectively and added, which permits to obtain the dither addition pixel data. According to the addition of the dither coefficients, as viewed by the pixel unit described above, it is possible to represent luminance equivalent to 8 bits only with upper 4 bits of the dither addition pixel data. The pixel drive data generator circuit 2 extracts, for example, upper four bits from the aforementioned dither addition pixel data, and makes it into four-bit multiple level grayscale pixel data PDs which is represented by dividing the luminance levels for each pixel into 12 levels (first to twelfth levels) as shown in FIG. 5. In addition, the pixel drive data generator circuit 2 converts sequentially the multiple grayscale pixel data PDS corresponding to each pixel, to 11-bit pixel drive data GD according to a data conversion table as shown in FIG. 5, and provides it to the forced lighting processing circuit 3. In this event, the logical level for each of the first to the eleventh bits in the pixel drive data GD shows whether address discharge (later described) is generated or not in the sub-field (later described) corresponding to the bit place. In other words, in the pixel drive data GD, the first and the eleventh bits correspond to the start and end sub-fields, respectively. When the logical level is 1, for example, the logical level does not generate address discharge, while the logical level is 0, address discharge is not generated in the sub-field corresponding to the bit place.

The forced lighting processing circuit 3 supplies to the memory 4, pixel drive data GGD obtained by submitting each of the pixel drive data GD for each pixel to forced lighting processing (later described). Further, the pixel drive data GGD is 11-bit data having a bit patters different with each of grayscale levels, as shown in FIG. 5.

The memory 4 sequentially writes the aforementioned pixel drive data GGD. Here, when pixel drive data GGD(_{1,1})-GGD(_{n,m}) equivalent to one screen, i.e., equivalent to (n×m) number corresponding to the first row, first column—n-th row, m-th column, is finished to be written, the memory 4 performs read operation as described below.

First, the memory 4 judges the first bit in each of the pixel drive data GGD (_{1,1})-GGD (_{n,m}) to be pixel drive data DB(_{1,1})-GGD (_{n,m}) read it, display line by display line, in the sub-field SF1, later described, and supplies it to the address driver 55. Next, the memory 4 judges the second bit in each of the pixel drive data GGD (_{1,1})-GGD (_{n,m}) to be pixel drive data DB(_{1,1})-DB (_{n,m}), read it, display line by display line, in the sub-field SF2, later described, and supplies it to the address driver 55.

Below, in the same manner, the memory 4 separates and reads the bits of the pixel drive data GGD (_{1,1})-GGD (_{n,m}) with respect to the same bit place, and supplies to the address driver 55 as pixel drive data bit DB (_{1,1})-DB (_{n,m}), respectively, in the subfields corresponding to the bit place.

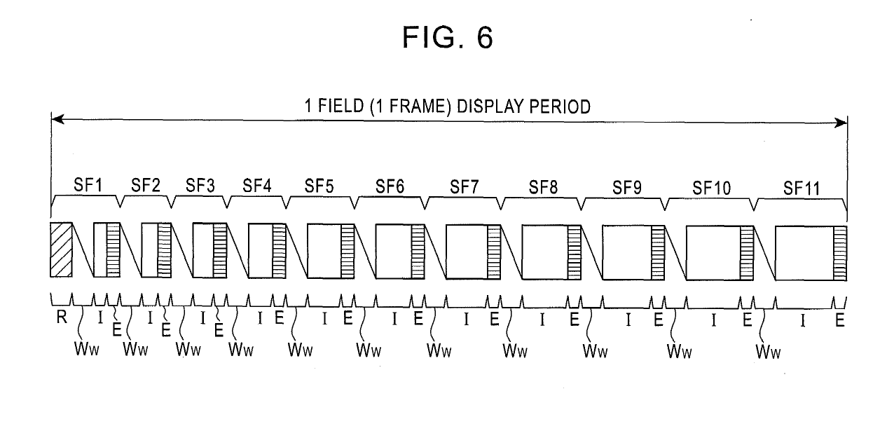

The drive control circuit 56 supplies various control signals to drive the PDP 50, according to a light emission sequence using the sub-field method (sub-frame method) as shown in FIG. 6, to a panel driver comprised of a X electrode driver 51, a Y electrode driver 53 and an address driver 55.

In other words, the drive control circuit 56, as shown in FIG. 6, supplies to the panel driver, various control signals to cause to sequentially perform driving in each of the sub-fields SF1-SF11, respectively, for one field or one frame display period (hereinafter called “unit display period”), in conformity with the selective write address stage Ww, the sustain stage I and the erasure stage E, respectively. Further, the drive control circuit 56 supplies to the panel driver, various control signals to cause to perform driving, according to the reset stage R, in advance to the selective write address stage Ww, limitedly in the first sub-field SF1 within the unit display period.

The panel driver (X electrode driver 51, Y electrode driver 53, address driver 55) performs driving to the PDP 50, as described below, by applying various drive pulses to the column electrode D, row electrodes X and Y in the PDP 50, in correspondence with various control signals supplied by the drive control circuit 56.

First, in the reset stage R which is performed only in the first sub-field SF1, the Y electrode driver 53 applies a reset pulse to all of the row electrodes Y₁-Yₙ. With such application of the reset pulse, reset discharge is generated in all the discharge cells PC. By such reset discharge, wall load remaining near the row electrodes X and Y, respectively in each of the discharge cells PC is erased, and all the discharge cells PC are initialized to non-light emitting mode state.

Next, in the selective write address stage Ww in each of the sub-fields SF1-SF11, the address driver 55 generates a pixel data pulse (later described) having a pulse voltage which corresponds to the logical level of the pixel drive data bit DB corresponding to the sub-field, and applies it to the column electrodes D₁-Dₘ, sequentially display line by display line. For example, the address driver 55 generates a high-voltage pixel data pulse when a pixel drive data bit DB is the logical level 1 indicating setting the discharge cell to light emitting mode, and a low-voltage (0 volt, for example) pixel data pulse when the logical level is 0 indicating setting to non-light emitting mode. Further, during this period, the Y electrode driver 53 applies, sequentially and alternatively, write scanning pulses (later described) to each of the row electrodes Y₁-Yₙ, in synchronism with each application timing of a pixel data pulse group respectively comprised of one display line, as described above. In this event, between the column electrode D and the row electrode Y in the discharge cell PC, to which high-voltage pixel data pulse is applied simultaneously with the aforementioned write scanning pulse, selective write address discharge is generated. Together with such discharge, the wall electric charge of a desired volume is formed in the discharge cell PC, and the cell is set to the light emitting mode state. On the other hand, in the cell to which low-voltage pixel data pulse is applied with such write scanning pulse, the selective write address discharge, as described above, is not generated, and the state immediately before, i.e., the non-light emitting mode state is maintained.

Next, in the sustain stage I in each of the sub-fields SF1-SF11, the X electrode driver 51 and the Y electrode driver 53 apply sustain pulses alternately to the row electrodes X and Y by the repetition frequency corresponding to the luminance weight of the sub-field. At each time when the sustain pulse is applied, sustain discharge is generated between the row electrodes X and Y in the discharge cell PC which is in the light emitting mode state. In correspondence with such sustain discharge, light irradiated from the fluorescent material layer 17, is irradiated to outside through the front-side transparent plate 10, which permits display light emission by the number of frequency corresponding to the luminance weight of the sub-field SF. Specifically, in the light emission drive sequence shown in FIG. 6, the nearer to the start sub-field a sub-field is within the unit display period, the smaller the luminance weight allocated to the sub-field becomes.

Further, in the erasure stage E in the sub-fields SF1-SF11, the Y electrode driver 53 applies erasure pulses to all the row electrodes Y₁-Yₙ. In correspondence with such erasure pulses, erasure discharge is generated only in the discharge cells PC, which are in light emitting mode. Such erasure discharge causes the discharge cell PC in the light emitting mode to shift to the non-light emitting mode.

The aforementioned driving is performed according to the 12 types of the pixel drive data GGD, shown in FIG. 5. According to such driving, as shown in FIG. 5, except when the luminance level 0 is represented (the first grayscale level), write address discharge is generated in the discharge cell PC (marked with a double circle) in each of the sub-fields which are consecutive by the number corresponding to the luminance levels to represent, starting from the start sub-field SF1, and the discharge cell PC is set to the light emitting mode. Therefore, the discharge cell PC is set to the light emitting mode in each of the sub-fields consecutive by the number corresponding to the halftone luminance, and light emission accompanied with the sustain discharge is repeated by the frequency allotted to each of the sub-fields (marked with a double circle). In this event, the luminance corresponding to the total sum of the sustain discharge generated within the unit display period is viewed. Therefore, according to the twelve types of the light emission patterns by the first to twelfth grayscale level drive, as shown in FIG. 5, the halftone luminance equivalent to 12 grayscale levels is represented which corresponds to the total frequency of the sustain discharge generated in each of the sub-fields indicated with a double circle.

Thus, the plasma display apparatus shown in FIG. 1, is configured to perform the driving of the PDP 50, as shown in FIGS. 5 and 6, based on the pixel drive data GGD.

Here, such pixel drive data GGD is obtained after the forced lighting processing circuit 3 performs the following forced lighting processing for the pixel drive data GD corresponding to the luminance grayscale level.

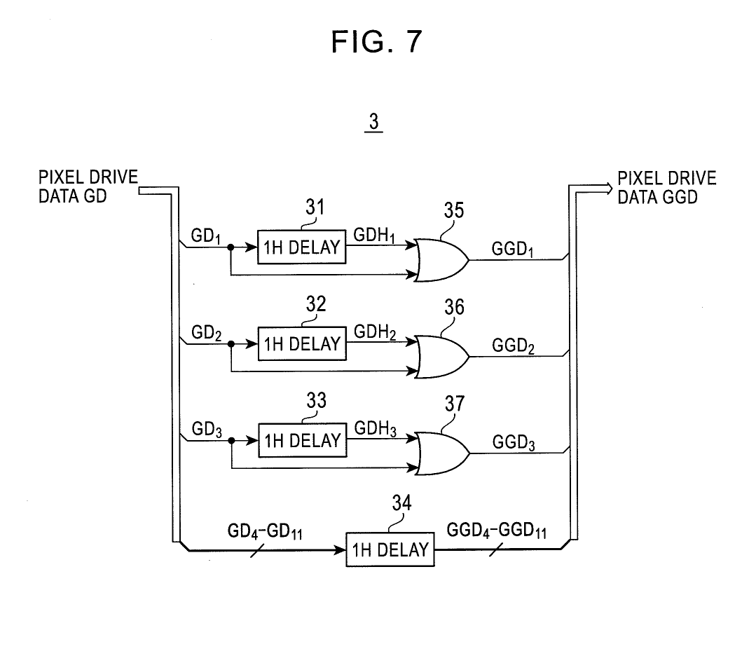

FIG. 7 is a diagram showing the internal configuration of the forced lighting processing circuit 3.

As shown in FIG. 7, the forced lighting processing circuit 3 is comprised of 1H delay circuits 31-34, and OR-gates 35-37.

The 1H delay gate 31 supplies to the OR gate 35 as a delayed first bit GDH₁, the first bit (GD₁) in such pixel drive data GD, which is delayed by a period used to supply the pixel drive data equivalent to one display line (number of m) (hereinafter called “1H period”). The OR gate 35 outputs, as the first bit (GD₁) in the pixel drive data GDH₁, a result of the logical sum of such delayed first bit GDH₁ and the first bit (GD₁) in the pixel drive data GD. The 1H delay circuit 32 supplies to the OR gate 36, as the delayed second bit GDH₂, the second bit (GD₂) in the pixel drive data, which is delayed for said 1H period. The OR gate 36 outputs, as the second bit (GGD₂) in the pixel drive data GGD, a result of the logical sum of said delayed second bit GDH₂, and the second bit in the pixel drive data GD. The 1H delay circuit 33 supplies to the OR gate 37 as the delayed third bit GDH₃, the third bit (GD₃) in the pixel drive data GD. The OR gate 37 outputs as the third bit (GD₃) in the pixel drive data GGD, a result of the logical sum of said delayed third bit GDH₃, and the third bit (GD₃) in the pixel drive data GD. The 1H delay circuit 34 outputs, as the fourth bit (GGD₄)-eleventh bit (GGD₁₁) in the pixel drive data GGD.

In other words, the forced lighting processing circuit 3 processes such that the logical level for each bit is the fourth bit-eleventh bits of the pixel drive data GGD as they are, in correspondence with the fourth-eleventh bits which correspond to the sub-fields larger than the predetermined luminance weight value among the first-eleventh bits in the pixel drive data GD.

On the other hand, with respect to the first-third bits corresponding to the sub-fields SF1-SF3 which are smaller than the predetermined luminance weight value, the forced lighting processing circuit 3 calculates per bit place, a logical sum with a bit to be supplied after one-hour period, and supplies the result to the memory 4, as the first-third bits of the pixel drive data GGD. In other words, to the first-third bits of the pixel drive data GD, the forced lighting processing circuit 3 calculates, for each bit place, a logical sum with the bit (first-third bits) of the pixel drive data GD corresponding to the discharge cell adjacent on the lower side of the discharge cell, for each of the pixel drive data GD corresponding to each discharge cell.

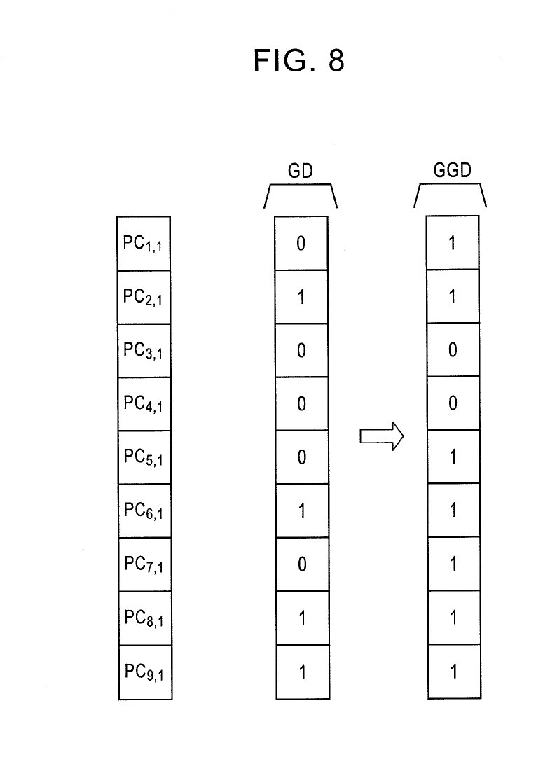

For example, as shown in FIG. 8, when the first bit of the pixel drive data GD corresponding to the discharge cell PC₁, has a logical level of 0, and if the first bit of the pixel drive data GD corresponding to the discharge cell PC_{2,1} adjacent thereto on the lower side has a logical level of 1, the logical level, which is a logical sum of both bits, is obtained as the first bit of the pixel drive data GD corresponding to the discharge cell PC_{1,1}. Further, when the first bit of the pixel drive data GD corresponding to the discharge cell PC_{3,1} adjacent thereto on the lower side has a logical level of 0, and if the first bit of the pixel drive data GD corresponding to the discharge cell PC_{3,1} adjacent thereto on the lower side has a logical level of 0, the logical level of 0, which is a logical sum of both bits, as the first bit of the pixel drive data GGD corresponding to the discharge cell PC_{4,1}. Further, when the first bit of the pixel drive data GD corresponding to the discharge cell PC_{3,1} adjacent thereto on the lower side has a logical level of 0, and if the first bit of the pixel drive data GD corresponding to the discharge cell PC_{4,1}, adjacent thereto on the lower side has a logical level of 0, the logical level of 0, which is a logical sum of both bits, is obtained as the first bit of the pixel drive data GGD corresponding to the discharge cell PC_{4,1}. Further, when the first bit of the pixel drive data GD corresponding to the discharge cell PC5, and if the first bit of the pixel drive data GD corresponding to the discharge cell PC_{6,1} adjacent thereto on the lower side has a logical level of 1, the logical level of 1, which is a logical sum of both bits, is obtained as the first bit of the pixel drive data GGD corresponding to the discharge cell P_{5,1}.

That is, the forced lighting processing circuit 3 performs forced lighting processing so that the P-th bit (P:1, 2, 3) of the pixel drive data GD is forcibly changed to a logical level of 1, which indicates the light emitting mode, when the logical level of the P-th of the pixel drive data GD corresponding to the discharge cell adjacent thereto on the lower side is a logical level of 1, even if the logical level is 0 which indicates non-light emitting mode.

Here, when each bit in the pixel drive data GGD has a logical level of 1, in the selective write address stage Ww in correspondence with the bit place, write address discharge is generated between the column electrode D and the row electrode Y in the discharge cell PC, and the discharge cell PC is set to the light emitting mode.

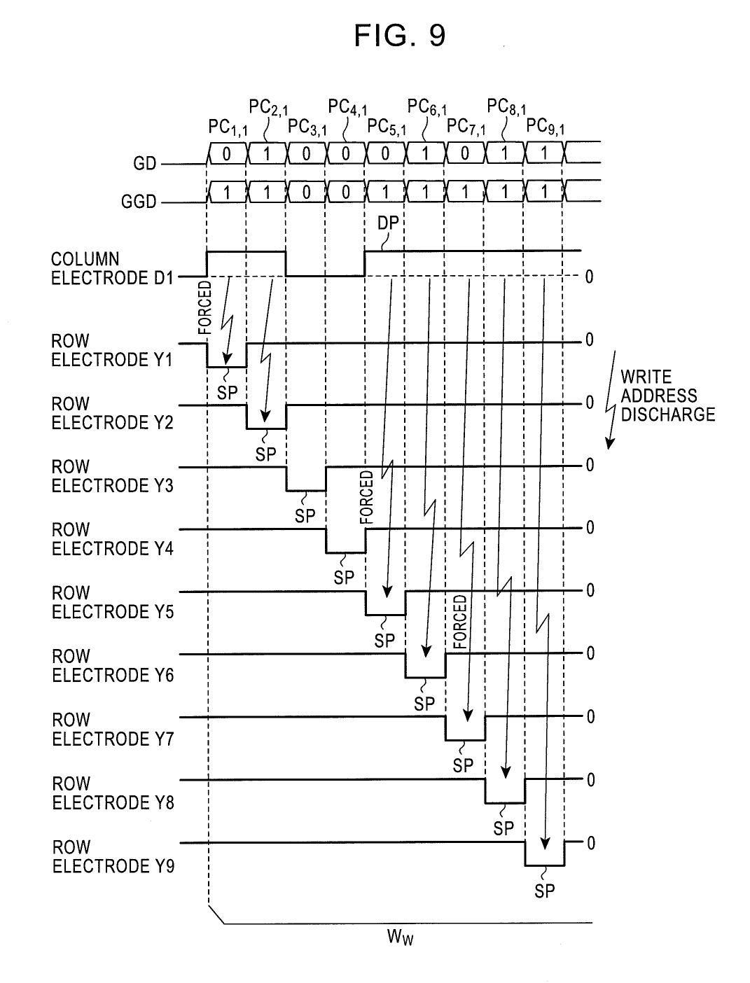

Below, such operation is given with an example shown in FIG. 9.

Further, FIG. 9 is a diagram showing the drive operation at the discharge cells PC_{1,1}-PC_{9,1}, respectively performed in the selective write address stage Ww.

First, when the first bit in each of the pixel drive data GD corresponding to each of the discharge cells PC_{1,1}-PC_{9,1} is a bit series [0,1,0,0,0,1,0,1,1] in the pixel drive data GD corresponding to each of the discharge cells PC_{1,1}-PC_{9,1}, the forced lighting processing circuit 3 submits such bit series to the aforementioned forced lighting processing, and thereby obtains the pixel drive data GGD which has a bit series of the first bit of [1,1,0,0,1,1,1,1,1]. To each bit in the aforementioned bit series by the pixel drive data GGD, the address driver 55 sequentially applies to the column electrode D₁, positive-polarity high voltage pixel data pulse DP if the bit has a logical level of 1, and low voltage (0 bolt) pixel data pulse DP if the bit has a logical level of 0, as shown in FIG. 9. During this period, in synchronization with each of the pixel data pulses DP applied to each bit, as shown in FIG. 9, the Y electrode driver 53 applies sequentially and alternatively the negative-polarity scanning pulse from the row electrode Y₁ to Y₉. In this event, while a scanning pulse is applied, between the column electrode D1 and row electrode Y in the discharge cell PC to which positive-polarity high voltage pixel data pulse DP is applied simultaneously, write discharge is generated, and the discharge cell is changed to the light emitting mode. Further, while the scanning pulse SP is applied, in the discharge cell PC to which low-voltage pixel data pulse DP is applied, the write address discharge as described above is not generated, and the discharge cell PC remains as it is immediately before, i.e., in the non-light emitting mode state.

Here, with the pixel drive data GD having the bit series of [0,1,0,0,0,1,0,1,1], in the discharge cells PC_{2,1}, PC_{6,1}, PC_{8,1} and PC_{9,1}, which correspond to the bit of the logical level 1, as shown in FIG. 9, write address discharge is generated. In this event, in the discharge space of the discharge cell PC, electrically-charged particles are generated in correspondence with generation of various types of discharge, but the volume thereof decreases gradually with the lapse of time when the discharge stops, and the discharge probability drops. For example, as shown in FIG. 9, when the discharge cell is driven according to the pixel drive data GD, in the discharge cell PC_{9,1}, write address discharge is generated in the discharge cell PC_{8,1} adjacent thereto right above, immediately before generation of the write address discharge. The electrically-charged particles generated by the discharge disperse in the discharge cell PC_{9,1}, resulting in an amount of electrically-charged particles required for the discharge. By the electrically-charged particles, in the discharge cell PC_{9,1}, the generation probability of discharge is increased greatly, which permits to securely generate write address discharge. However, when a discharge cell is driven with the pixel drive data GD, in the discharge cell PC_{2,1} (or PC_{6,1}, PC_{9,1}), the write address discharge is not generated in the discharge cell PC_{1,1} (or PC_{5,1}, PC_{7,1}) adjacent directly above at the stage immediately before the write address discharge is generated, and therefore, the density of the electrically-charged particles is low. Therefore, in the discharge cell PC_{2,1}, in comparison with the case of the aforementioned discharge cell PC_{9,1}, the probability of generating the address discharge becomes lower.

Therefore, with respect to the discharge cells adjacent on the upper side of the discharge cells (PC_{2,1}, PC_{6,1}, PC_{8,1}, PC_{9,1}) which generate write address discharge according to the pixel drive data GD, the write address discharge is made forcibly, regardless of the pixel drive data GD. In other words, as shown in FIG. 9, even when the logical level is 0, which indicates that the value of the pixel drive data GD signifies setting to non-light emitting mode, the drive operation is made with the pixel drive data GGD which replaces the level with the logical level of 1, which indicates setting to light emitting mode. Thereby, when write address discharge is generated in the discharge cells PC_{2,1}, PC_{6,1}, PC_{8,1} and PC_{9,1}, write address discharge is necessarily generated also in the discharge cells PC_{1,1}, PC_{5,1}, PC_{7,1}, PC_{8,1} adjacent on the upper side. Therefore, by such write address discharge generated forcibly, electrically-charged particles are obtained in an amount required to generate discharge, immediately thereafter, write address discharge is generated securely in the discharge cells PC_{2,1}, PC_{6,1}1 and PC_{8,1}, respectively. In this event, there are some cases that discharge is not generated in the discharge cells (PC_{1,1}, PC_{5,1}, PC_{7,1}, PC_{8,1}) which are selected as a target of forced write address discharge. In such case, however, discharge probability is increased in the discharge cells (PC_{2,1}, PC_{6,1}, PC_{8,1}) in which write address discharge must be generated intrinsically.

Therefore, according to the aforementioned forced lighting processing, it is possible to obtain electrically-charged particles in an amount securely permitting write address discharge thereafter, without resort to reset discharge. Thereby, it is possible to drive discharge cells without generation of erroneous discharge, even when reset discharge is set to be weak, or is omitted to improve dark contrast.

Further, when such forced lighting processing is selected, in the screen of the PDP 50, there exist discharge cell PC which are forcibly set to light emitting mode, which sometimes results in degraded image.

For example, when a discharge cell PC is driven at the fourth grayscale level, as shown in FIG. 5, or a discharge cell PC adjacent directly above it is driven at the third grayscale level as shown in FIG. 5 according to the pixel drive data GD, the forced lighting processing is effected in SF3 in the discharge cell adjacent directly above it. Therefore, the discharge cell adjacent directly above it is driven at the fourth grayscale level, although it must be driven intrinsically at the third grayscale level. In this event, therefore, there appears a luminance difference between the two discharge cell PC, i.e., grayscale luminance error equivalent to the sustain discharge light emission in SF3, which results in degraded image.

Therefore, in the plasma display apparatus shown in FIG. 1, in the sub-fields SF1-SF11, as shown in FIG. 6, only the sub-fields SF1-SF3 for driving of low luminance component performs the aforementioned forced lighting processing. In this event, the driving as shown in FIG. 5, except a case of black display (first grayscale level), the aforementioned forced lighting processing is made necessarily in one of the sub-fields SF1-SF3, which permits favorable driving with reduced discharge probability drop due to lack of electrically-charged particles. Further, after the sub-fields SF3, electrically-charged particles is obtained by sustain discharge repeatedly generated in each sustain stage I. Therefore, if discharge is generated in one of the sub-fields SF1-SF3, which is placed at the start of the unit display period, discharge probability in the succeeding SF4-SF11, which results in a stable driving without performing the aforementioned forced lighting processing in the SF4-SF11, respectively.

Further, intrinsically in such forced lighting processing, as the discharge cell arranged on the same column electrode as the discharge cell to generate write address discharge is discharged forcibly, both are discharge cells responsible for light emission of the same color. Therefore, because there is no error in terms of color difference, erroneous light emission accompanied with forced discharge, is low in visibility.

Further, in the aforementioned embodiment, in all of the sub-fields SF1-SF3, the aforementioned forced lighting processing is performed, but it may be performed with respect to one of the SF1-SF3, or only two of the SF in SF1-SF3. For example, based on the pixel drive data GD, when driving at the fourth-twelfth graduation level, shown in Fig. is performed, the aforementioned forced lighting processing can be performed only with respect to the SF1 of the sub-fields SF1-SF3.

Further, the following drive operation can be performed in order to reduce the graduation luminance error which arises from the forced lighting processing performed, as described above.

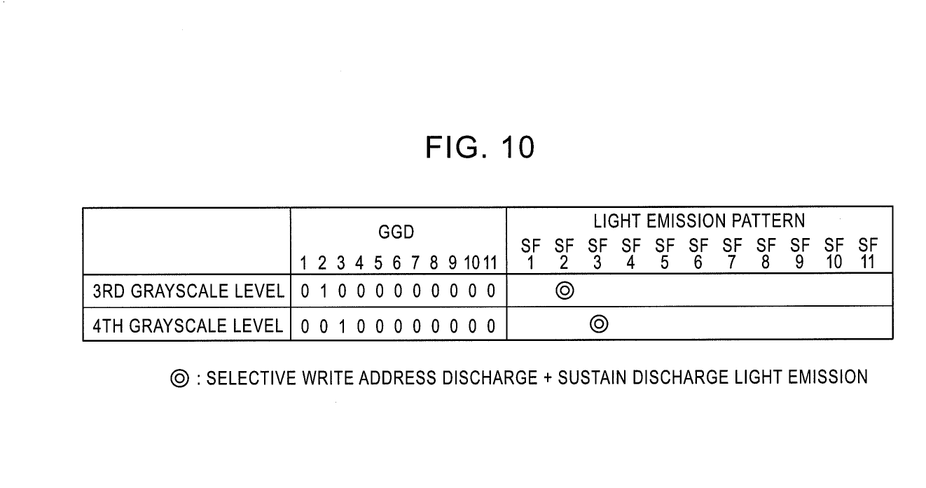

For example, when pixel drive data GD corresponding to a discharge cell PC represents the fourth grayscale level shown in FIG. 5 (sustain discharge in SF1-SF3), and a discharge cell PC adjacent directly thereupon, represents the third grayscale level (sustain discharge in SF1 and SF2), the forced lighting processing is performed in the SF3 in the discharge cell PC adjacent directly thereupon. Therefore, the discharge cell PC adjacent directly thereupon, is driven at the fourth grayscale level, which should be driven intrinsically at the third grayscale level. In this event, for the discharge cell PC adjacent directly thereupon, driving at the fourth grayscale level, described in FIG. 10 is performed in place of driving at the fourth grayscale level, described in FIG. 5. In other words, in this event, the forced lighting processing circuit 3 converts the pixel drive data GD of [11000000000] corresponding to the third grayscale level, shown in FIG. 5, into the pixel drive data GGD of [00100000000]. With such pixel drive data GGD, as shown in FIG. 10, write address discharge is generated only in the sub-fields SF1-SF11, as shown in FIG. 10 (marked with a double circle). Therefore, the discharge cell PC is set to light emitting mode only in SF3 in the sub-fields, while sustain discharge is generated only in the sustain stage I in the SF 3. On the other hand, with driving at the fourth grayscale level shown in FIG. 5, the discharge cell PC performs sustain discharge not only in the SF3, but also in SF1 and SF2. Therefore, with driving at the fourth grayscale level, shown in FIG. 10, the luminance error is smaller in driving at the third grayscale level, shown in FIG. 5, than driving at the fourth grayscale level, shown in FIG. 5. That is, even when driving is performed at high luminance, on a level higher than the luminance grayscale level corresponding to an input video signal by the forced lighting processing, the grayscale luminance error is lessened.

Further, in the aforementioned embodiment, by performing the forced write address discharge of a discharge cell adjacent directly above a discharge cell PC which is a target of setting the light emitting mode by pixel drive data GD, it is possible to achieve increased discharge probability in the discharge cell PC, or so-called “priming effect”. However, such priming effect can be obtained not only from a discharge cell adjacent directly above, but also when performing write address discharge of a discharge cell placed at a place equivalent to two lines, for example.

In this regard, when a discharge cell which is placed above by two display lines of a discharge cell PC to be set to light emitting mode, is set to light emitting mode, the aforementioned forced lighting processing may not be performed with respect to the discharge cell adjacent directly above the discharge cell. In other words, the forced lighting processing circuit 3 first judges, based on the pixel drive data GD, whether the discharge cell placed above by two display lines of the discharge cell which is set to light emitting mode, is set to light emitting mode. Further, the forced lighting processing circuit 3 performs the aforementioned forced lighting processing with respect to the pixel drive data GD corresponding to the discharge cell adjacent directly above the discharge cell, only when the discharge cell placed above by two display lines of the display cell PC which is set to light emitting mode is not set to light emitting mode. With such driving, the aforementioned grayscale luminance error can be lessened further more.

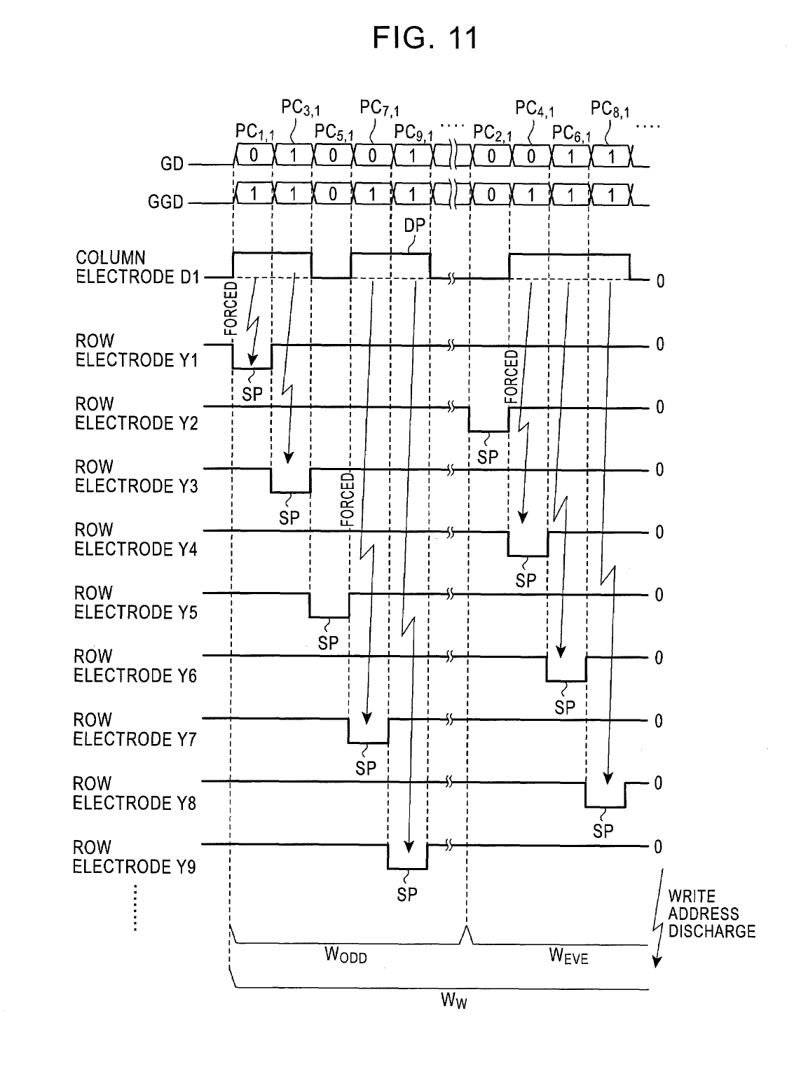

Further, by the use of the priming effect from the discharge cell placed above by two display lines, the aforementioned forced lighting processing may be performed with respect to the discharge cell placed above by two display lines in the discharge cell PC which is set to light emitting mode. For example, in the selective write address stage Ww, shown in FIG. 6, such forced lighting processing is performed when temporal dispersion is made with respect to the address operation (W_{ODD}) for the discharge cells belonging to an odd-number-th display line, and the address operation (W_{EVE}) to the discharge cells belonging to an even-number-th display line, as shown in FIG. 11.

In the front half of the selective write address stage (W_{ODD}) shown in FIG. 11, the address driver 55 sequentially applies to the column electrode D, display line by display line (number of m), the pixel data pulse DP based on the pixel drive data GGD corresponding to each of the discharge cells PC belonging to the odd-numbered display lines. During this time, as shown in FIG. 11, the Y-electrode driver 53, applies sequentially and alternatively a negative-polarity scanning pulse SP to an odd-number-th row electrode Y₁, Y₃, Y₅, Y₇, Y₉ . . . , Yₙ₋₁. Next, in the later half of the selective write address stage (W_{EVE}), the address driver 55 sequentially applies to the column electrode D, display line by display line (number of m), the pixel data pulse DP based on the pixel drive data GGD corresponding to each of the discharge cells PC belonging to the even-number display lines. During this time, as shown in FIG. 11, the Y-electrode driver 53, applies sequentially and alternatively a negative-polarity scanning pulse SP to an even-number-th row electrode Y₂, Y₄, Y₆, Y₈ . . . , Yₙ.

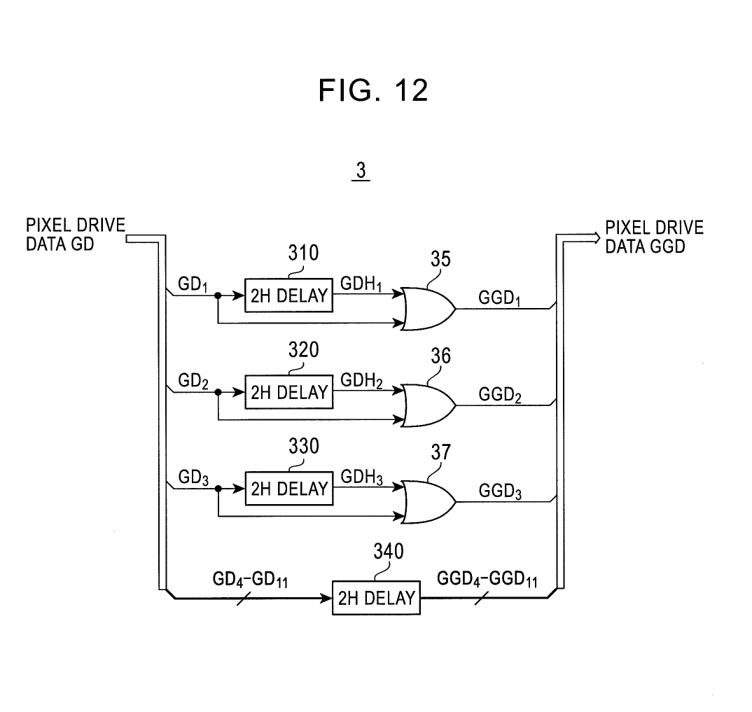

FIG. 12 is a diagram showing an example of the internal configuration of the forced lighting processing circuit 3 to be operated when performing the aforementioned forced lighting processing to discharge cells which are placed by two display lines of a discharge cell PC to be set to light emitting mode.

Further, in the configuration shown in FIG. 12, the 1H delay circuits 31-34, shown in FIG. 7, are replaced by the 2H delay circuits which output the pixel drive data GD in delay of two times the 1H delay period (hereinafter called “2H period”), respectively, and the other points of configuration and operation are the same as those shown in FIG. 7. With such configuration, the forced lighting processing circuit 3 forcibly changes to the logical level of 1, which indicates light emitting mode, the P-th bit (P:1, 2, 3) of the pixel drive data GD which corresponds to each of the discharge cells, when the P-th bit of the pixel drive data GD which corresponds to discharge cells placed by two display lines directly below has a logical level of 1.

Here, for example, when the bit series of the first bit in the pixel drive data GD which corresponds to each of the discharge cells PC_{1,1}-PC_{9,1} belonging to the column electrode D₁, is [0,0,1,0,0,1,0,1,1], the bit series is [0,1,0,0,1], as shown in FIG. 11, with respect to the pixel drive data GD which corresponds to each of the discharge cells PC_{1,1}, PC_{3,1}, PC_{5,1}, PC_{7,1}, PC_{9,1}, belonging to the odd-number-th display lines. In this event, the discharge cell PC_{1,1}, is placed by two display lines directly above PC_{3,1}, while the discharge cell PC_{3,1} is placed by two display lines above PC_{5,1}. Further, the discharge cell PC_{5,1} is placed by two display lines directly above PC_{7,1}, while the discharge cell PC_{7,1} is placed by two lines directly above PC_{9,2}. Therefore, the forced lighting processing circuit 3 obtains the pixel drive data GGD having a bit series in which the bit series of the first bit is [1,1,0,1,1], as shown in FIG. 11, by performing the aforementioned forced lighting processing with respect to such bit series. On the other hand, the bit series of the pixel drive data GD which corresponds to each of the discharge cells PC_{2,1}, PC_{4,1}, PC_{6,1}, PC_{8,1}, belonging to the odd-number-th display lines, is [0,0,1,1], as shown in FIG. 11. In this event, the discharge cell PC_{2,1} is placed by two display lines directly above PC_{4,1}, while the discharge cell PC_{4,1} is placed by two display lines directly above PC_{6,1}. Further, the discharge cell PC_{6,1} is placed by two display lines directly above PC_{8,1}. Therefore, the forced lighting processing circuit 3 obtains the pixel drive data GGD having a bit series in which the bit series of the first bit is [0,1,1,1], as shown in FIG. 11, by performing the aforementioned forced lighting processing with respect to such bit series.

The address driver 55 sequentially applies to the column electrode D₁, as shown in FIG. 11, the pixel data pulse DP of positive-polarity high voltage when the bit has a logical level of 1, and the pixel data pulse DP of low voltage (0 bolt) when the bit has a logical level of 0, respectively, for each bit in the bit series in the aforementioned pixel drive data GGD. In other words, the address driver 55 applies to the column electrode D₁, the pixel data pulse DP corresponding to the bit series in the pixel drive data GGD in the former half (W_{ODD}) to the selective write address stage Ww, and applies to the column electrode D₁, the pixel data pulse DP corresponding to the bit series [0,1,1,1] in the pixel drive data GGD in the later half (W_{EVE}) of the selective write address stage Ww. In this event, address discharge is generated between the column electrode D₁ and row electrode Y in the discharge cell PC, to which positive-polarity high-voltage pixel data pulse DP is applied simultaneously, while the scanning pulse SP is applied, and this discharge cell PC is shifted to light emitting mode. However, while the scanning pulse SP is applied, in the discharge cell PC, to which low-voltage pixel data pulse DP is applied, the aforementioned write address discharge is not generated, and the discharge cell PC remains in the immediately preceding state, i.e., in non-light emitting mode.

Here, for example, in the second half (W_{ODD}) of the selective write address stage Ww, as shown in FIG. 11, with the pixel drive data GD having a bit series of [0,1,0,0,1], write address discharge is generated in each of the discharge cells PC_{3,1} and PC₉, corresponding to the bit of the logic level of 1. In this event, in order to increase the probability of write address discharge in each of the discharge cells PC_{3,1} and PC_{9,1}, write address discharge is forcibly made in each of the discharge cells PC_{1,1} and PC_{7,1}, which are placed by two display lines above the discharge cell PC_{3,1} and PC_{9,1}, respectively. In other words, as shown in FIG. 1, even if the value of the pixel drive data GD corresponding to the discharge cells PC_{1,1} and PC_{7,1} has a logical level of 0, which indicates setting to non-light emitting mode, driving is performed in response to the pixel drive data GGD, in which logical level is replaced by a logical level of 1, which indicates setting to light emitting mode. Thereby, when write address discharge is made in the discharge cells PC_{3,1} and PC_{9,1}, immediately theretofore, necessarily, write address discharge is generated also in the discharge cells PC_{1,1} and PC_{8,1}, which are placed by two display lines directly thereon. Thus, because of effect of the write address discharge forcibly made, regardless of the pixel drive data GD, a necessary amount of electrically-charged particles is obtained immediately theretofore, and write address discharge is generated securely in each of the discharge cells PC_{1,1} and PC_{8,1}.

Further, as described above, the discharge cells in which sustain discharge is generated, come to high discharge probability at the selective write address stage Ww after the sustain stage I, because of effect of the electrically-charged particles generated by discharge thereof. In this event, the volume of electrically-charged particles generated sustain discharge becomes less with the lapse of time, but the volume thereof required for discharge is obtained during the display period of one field. Therefore, only with respect to the discharge cell PC in which any sustain discharge has not been generated in the subfield immediately theretofore, the aforementioned forced lighting processing can be performed.

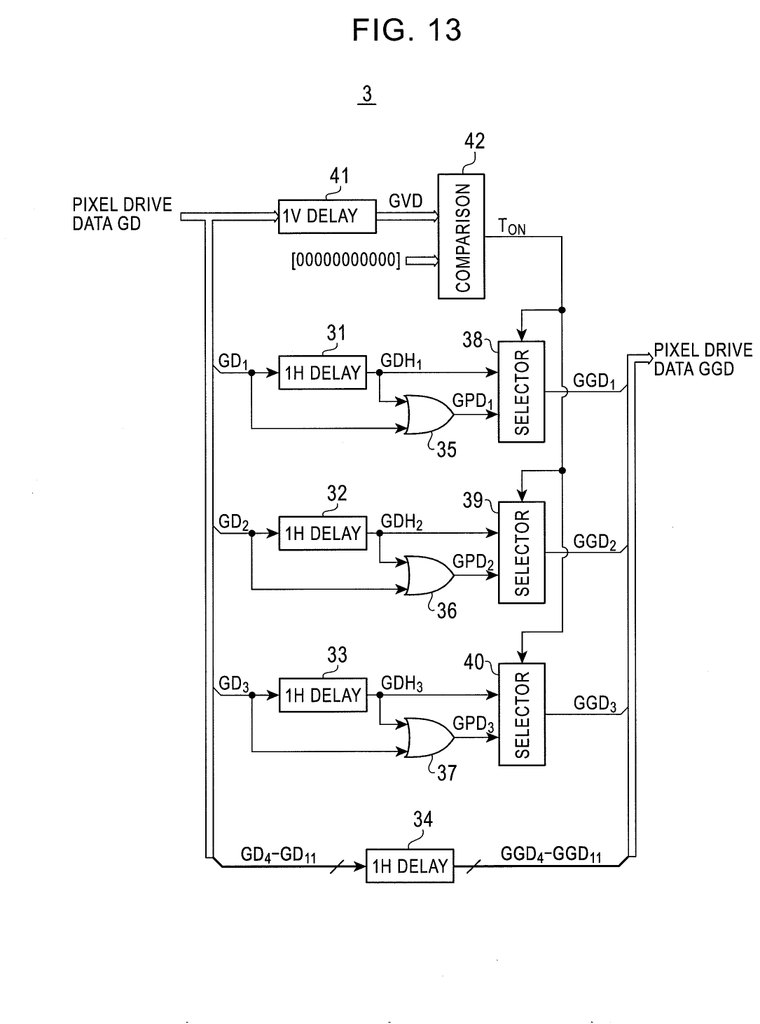

FIG. 13 is a diagram showing another internal configuration of the forced lighting processing circuit 3 made in consideration of such points.

In an embodiment shown in FIG. 13, the forced lighting processing circuit 3 is comprised of 1H delay circuits 31-34, selectors 35-37, 1V delay circuit 41 and comparator 42.

The 1H delay circuit 31 supplies to the OR gate 35 and selector 38 as delayed first bit GDH1, the first bit in the pixel drive data GD, in which the first bit (GD₁) is delayed by 1H period. The OR gate 35 supplies to the selector 38 as the forced lighting first bit, a result of the logical sum of such delayed first bit GDH₁ and the first bit (GD₁) in the pixel drive data GD. The selector 38 selects GPD₁ in the forced lighting first bit GPD₁ and delayed first bit GDH₁, when a forced lighting ON signal TON (later described) of the logical level of 1 to perform the forced lighting processing is supplied, and outputs it as the first bit (GGD₁) in the pixel drive data GGD. On the other hand, when the forced lighting ON signal TON of the logical level of 0 is supplied, the selector 38 selects GDH₁ in the forced lighting first bit GPD₁ and delayed first bit GDH₁, and outputs it as the first bit (GGD₁) in the pixel drive data GGD.

The 1H delay circuit 32 supplies to the OR gate 36 and selector 39 as delayed second bit GDH₂, the second bit (GD₂) in the pixel drive data GD, which is delayed by 1H period. The OR gate 36 supplies to the selector 39 as forced lighting second bit GPD₂, a result of the logical sum of such delayed second bit GDH₂ and the second bit (GD₂) in the pixel drive data GD. The selector 39 selects GPD₂ in the forced lighting first bit GPD₂ and delayed first bit GDH₂, when a forced lighting ON signal TON (later described) of the logical level of 1 to perform the forced lighting processing is supplied, and outputs it as the second bit (GGD₂) in the pixel drive data GGD. On the other hand, when the forced lighting ON signal TON of the logical level of 0 is supplied, the selector 39 selects GDH₂ in the forced lighting second bit GPD₂ and delayed second bit GDH₂, and outputs it as the second bit (GGD₂) in the pixel drive data GGD.

The 1H delay circuit 33 supplies to the OR gate and selector 40 as the delayed third bit GDH₃, the third bit (GD₃) in the pixel drive data GD, which is delayed by one-hour period. The OR gate 37 supplies to the selector 40, a result of the logical sum of such third bit GDH₃ and the third bit (GD₃) in the pixel drive data GD. The selector 40 selects GPD₃ in the forced lighting third bit GPD₃ and delayed third bit GDH₃, when a forced lighting ON signal TON of the logical level of 1 to perform the forced lighting processing is supplied, and outputs it as the third bit (GGD₃) in the pixel drive data GGD. On the other hand, when the forced lighting ON signal TON of the logical level of 0 is supplied, the selector 40 selects GDH₃ in the forced lighting third bit GPD₃ and delayed third bit GDH₃, and outputs it as the third bit (GGD₃) in the pixel drive data GGD.

The 1H delay circuit 34 outputs each of the fourth bit (GGD₄)—the eleventh bit (GD₁₁) in the pixel drive data GD, which are delayed by the aforementioned one-hour period, as the fourth bit (GGD₄)-eleventh bit (GGD₁₁) in the pixel drive data GGD.

The 1V delay circuit 41 supplies to the comparator 42 as the 1V delay pixel drive data GVD, the 11-bit pixel drive data for each pixel, in which such pixel drive data GD (GD₁-GD₁₁) are delayed by a display period equivalent to one field (or one frame) (hereinafter called “1V period”). The comparator 42 judges whether the 11-bit series of such 1V delay pixel drive data GVD conforms to the bit series [00000000000] corresponding to the first grayscale level shown in FIG. 5 (indicated in black). The comparator 42 supplies to the selectors 38-40, the forced lighting ON signal TON having a logical level of 0, when non-conformity of both bit series is judged, while the forced lighting ON signal TON is supplied to the selectors 38-40, if conformity of both bit series is judged.

In other words, according to the forced lighting processing circuit 3 shown in FIG. 13, when the pixel drive data GD which precedes by one field, is a bit series [00000000000] corresponding to the first grayscale level which indicates black display, configuration thereof is same as the configuration shown in FIG. 7. On the other hand, when the pixel drive data GD which precedes by one field is a bit series other than the bit series [00000000000] which corresponds to the first grayscale level indicating the black display, the pixel drive data GD, which is delayed by one-hour period is pixel drive data GDD as it is. Here, when the pixel drive data is a bit series [00000000000] indicating the black display, any sustain discharge is generated for the one-field (or one frame) period. However, when the pixel drive data GD is one other than the bit series [00000000000], sustain discharge is generated at least in one SF1, and electrically-charged particles generated by the sustain discharge decreases with the lapse of time, maintaining a volume required for discharge of one field display period.

Then, in the forced lighting processing circuit 3 shown in FIG. 13, limitedly only when the pixel drive data GD which precedes by one field is a bit series [00000000000] which corresponds to the first grayscale level indicating the black display, only the first-third bits undergo the aforementioned forced lighting processing.

Further, in the driving shown in FIG. 5, the selective write address discharge is generated at each of the sub-fields continuous from the start, so that (N+1) halftone luminance display is made by using a n-number of the SF. The selective write address discharge may not necessarily be generated in the consecutive SF. For example, halftone luminance equivalent to 2^{N} grayscale level can be presented by combination of sub-fields generating the selective write address discharge in each of the N-number SF.

### EMBODIMENT 2

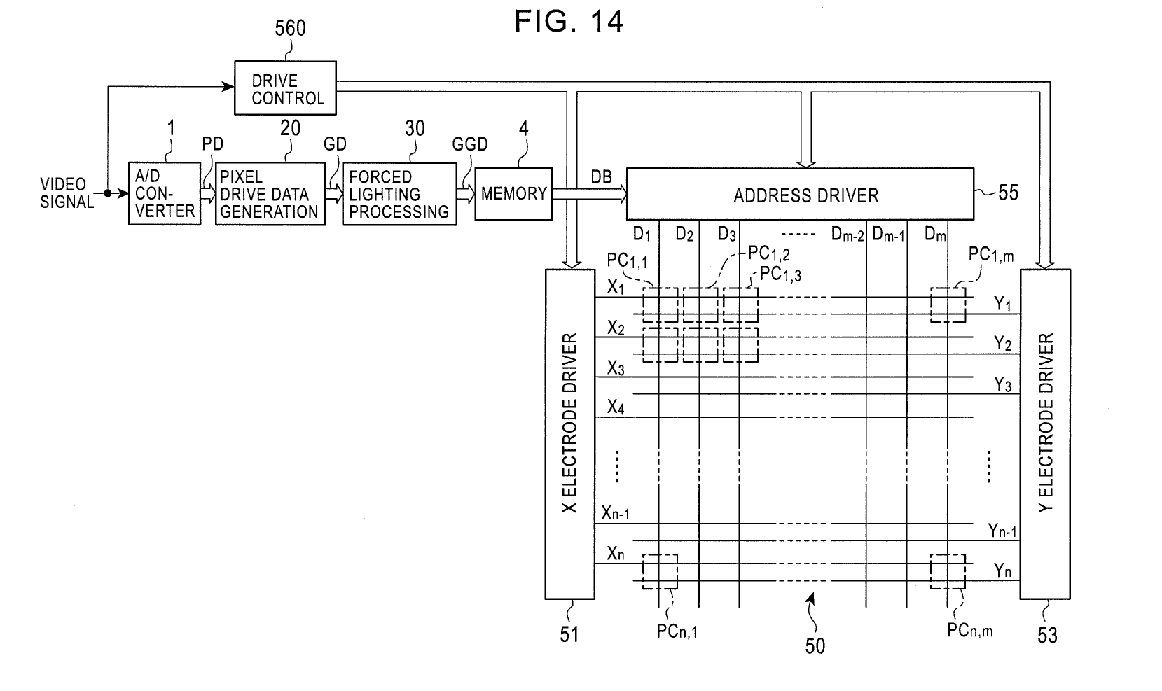

FIG. 14 is a diagram showing another schematic configuration of the plasma display apparatus driving a plasma display panel according to the driving method of the present invention.

Here, the plasma display panel PDP 50 shown in FIG. 14 has the same configuration as PDP 50 shown in FIG. 1.

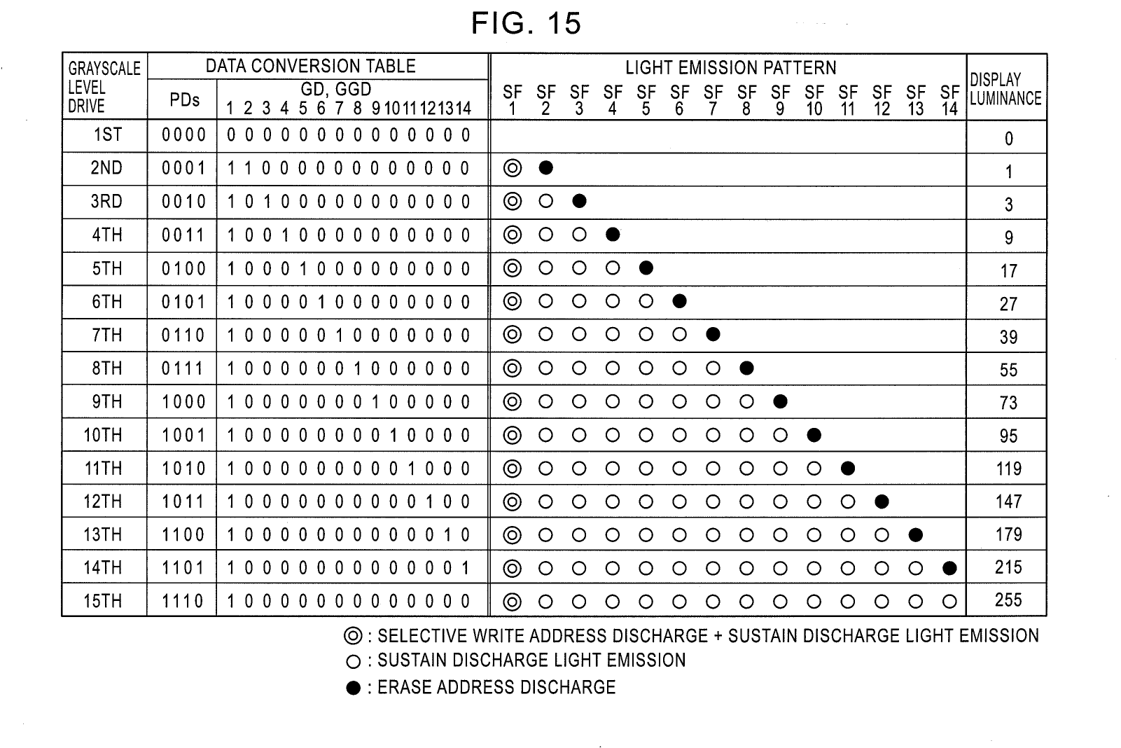

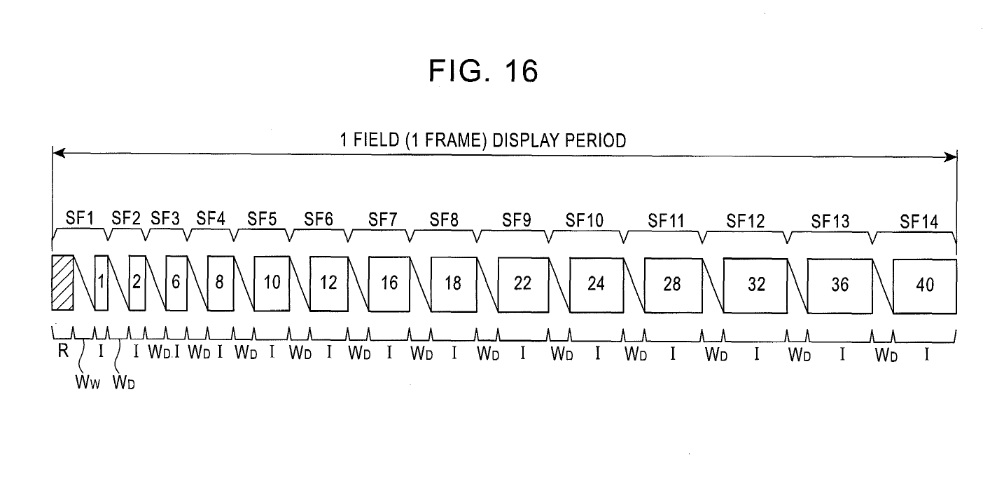

In FIG. 14, the A/D converter 1 converts an input video signal into pixel data PD of 8 bits, for example, in correspondence with each of pixels, and supplies it to the pixel data generation circuit 20. The pixel drive data generation circuit 20 first submits each of the pixel data PD for each pixel to multiple-level grayscale comprised of error diffusion processing and dither processing. Further, such multiple-level grayscale processing is the same processing as that made in the pixel drive data generation circuit, as described in FIG. 2. In other words, the pixel drive data generation circuit 20 submits the pixel data PD to the aforementioned multiple-level grayscale processing, which permits to obtain 4-bit multiple-level pixel data PDs indicating the luminance, by dividing all of the luminance area into 15 stages, as shown in FIG. 15. Then, the pixel data generation circuit 20 converts such multiple-level grayscale pixel data PDs to 14-bit pixel drive data GD in conformity with a data conversion table as shown in FIG. 15, and supplies it to the forced lighting processing circuit 30. Here, the logical level for each of the first-fourteenth bits in the pixel drive data GD indicates whether address discharge (later described) is generated in the sub-fields SF1-SF14 corresponding to the bit place, as shown in FIG. 16. In other words, the first bit of the pixel drive data GD corresponds to the sub-field SF1, and the fourteenth bit corresponds to the end sub-field SF14. When the logical level is 1, for example, address discharge is generated, while address discharge is not generated in the sub-fields corresponding to the bit place, when the logical level is 0.

The forced lighting processing circuit 30 supplies to the memory 4, the pixel drive data obtained by forced lighting processing with respect to each of the pixel drive data GD for each pixel.

The memory 4 sequentially writes the aforementioned pixel drive data GGD. Here, when writing is completed for data equivalent to one screen, i.e., pixel drive data GGD (_{1,1})-GGD (_{n,m}) equivalent to (n×m) number in correspondence with each of the first-line, first column—n-th row, m-th column pixels, read operation is performed as described below.

First, the memory 4 judges the first bit of each the pixel drive data GGD(_{1,1})-GGD(_{n,m}) to be the pixel drive data bits DB(_{1,1})-RDB(_{n,m}), reads them for each display line in the sub-fields, later described, and supplies them to the address driver 55. Next, the memory 4 judges the second bit of each the pixel drive data GGD(_{1,1})-GGD(_{n,m}) to the pixel drive data bits DB(_{1,1})-RDB(_{n,m}), reads for each display line in the sub-fields, later described, and supplies them to the address driver 55. Below, in the same manner, the memory 4 reads separately each of the pixel drive data GGD(_{1,1})-GGD(_{n,m}) in terms of the same bit place, and supplies to the address driver 55, each of them as the pixel drive data bits DB(_{1,1})-DB(_{n,m}) in the sub-fields corresponding to the bit place.

The drive control circuit 560 supplies to a panel driver comprised of a X-electrode driver 51, Y-electrode driver 53 and address driver 55, various control signals which drive the PDP 50 according to a light emission drive sequence employing the sub-field method (sub-frame method) shown in FIG. 16. In other words, the drive control circuit 560 supplies to the panel driver, various control signals which permit to sequentially perform drive operation according to a reset stage R, selective write address stage Ww and sustain stage I, respectively, in the start sub-field SF1 within one field (one frame) display period, as shown in FIG. 16. Further, in each of the sub-fields SF2-SF14, various control signals which permit to sequentially perform driving according to the selective erasure address stage W_{D} and sustain stage I, respectively, are supplied to the panel driver.

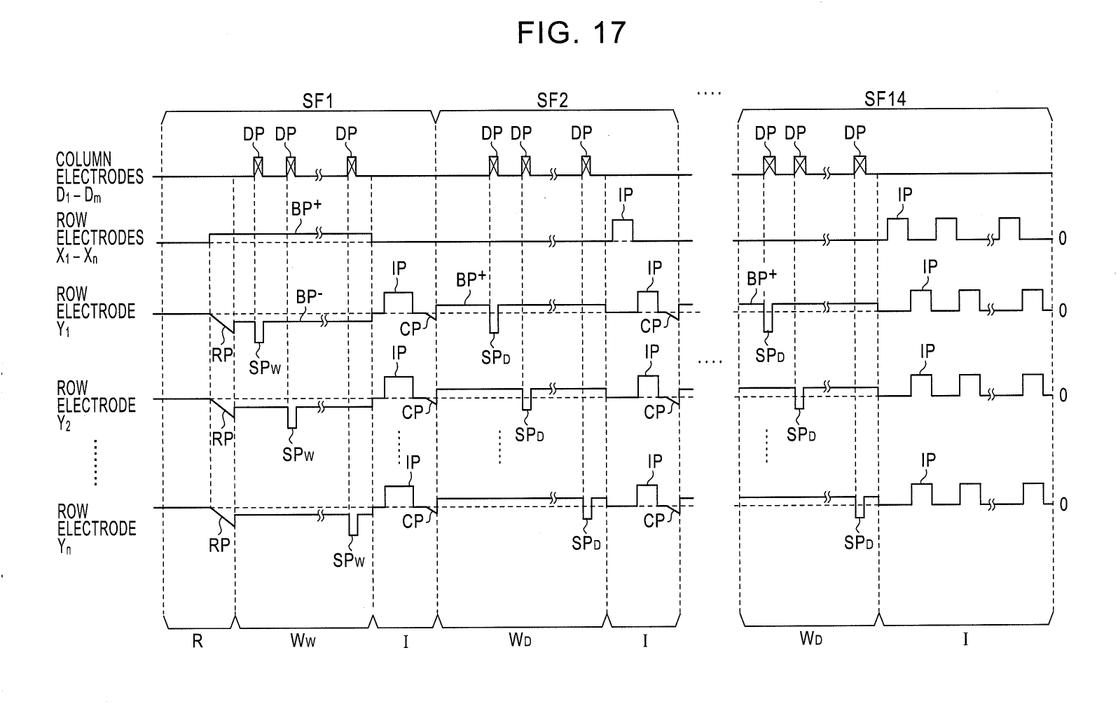

The panel driver, i.e., the X electrode driver 51, Y electrode driver 53 and address driver 55 generates various drive pulses according to the various control signals supplied from the drive control circuit 560, as shown in FIG. 17, and supplies them to the column electrode D, and row electrodes X and Y. Further, in FIG. 17, in the sub-fields SF1-SF14 shown in FIG. 16, only the start sub-field SF1, succeeding sub-field SF2, and the end sub-field F14, are extracted and displayed.

First, in the reset stage R in the sub-field SF1, the Y electrode driver 53 generates a reset pulse RP having a negative-polarity peak potential in which potential transition at the front edge is gradual with the lapse of time, and applies it to all of the row electrodes Y₁-Yₙ. Further, in the reset stage R, the X electrode driver 51 applies to the row electrodes X₁-Xₙ, respectively, a base pulse BP⁺ having positive-polarity peak potential totally while the aforementioned reset pulse RP is applied to the row electrode Y. As said negative-polarity reset pulse RP and positive-polarity base pulse BP⁺ are applied, slight reset discharge is generated between the row electrodes X and Y in all of the discharge cells PC. With such second reset discharge, a large portion of wall charge formed respectively near the row electrodes X and Y is erased. This puts all of the discharge cells PC in a condition where there is a slight amount of negative-polarity wall charge remaining near the row electrode X, and a slight amount of wall charge remaining near the row electrode Y, i.e., all of the discharge cells PC are initialized to non-light emitting mode. Further, as the aforementioned reset pulse RP is applied, slight discharge is generated also between the row electrode Y and column electrode D, and a portion of positive-polarity wall charge formed near the column electrode D in all of the discharge cells PC is erased. Thereby, it possible to perform adjustment in such that the wall charge remaining near the column electrode D in all of the discharge cells D is adjusted in an amount which enables to properly generate the selective write address discharge in the selective write address stage Ww, later described. In this regard, the negative-polarity peak potential in the reset pulse RP is set to a potential higher than a peak potential of the negative-polarity write scanning pulse SPw, later described, i.e., a potential near 0 volt. In other words, if the peak potential of the reset pulse RP is set to a potential lower than that of the write scanning pulse SPw, strong discharge is generated between the row electrode Y and column electrode D, which result in erasure of a large amount of wall charge formed near the column electrode D and unstable address discharge in the selective write address stage Ww.

Next, in the selective write address stage Ww in the sub-field SF1, the Y electrode driver 53 applies simultaneously to each of the row electrodes Y₁-Yₙ, a base pulse BP⁻ having negative-polarity peak potential, as shown in FIG. 17, and applies sequentially and alternatively to each of the row electrodes Y1-Yn, the write scanning pulse SPw having negative-polarity peak potential. During this period, the X driver 51 continues to apply the aforementioned base pulse BP⁺ to the row electrodes X₁-Xₙ. The voltage applied to the row electrodes X and Y by the base pulses BP⁺ and BP⁻ is lower than discharge start voltage of the discharge cell PC.

Further, in the selective write address stage Ww, the address driver 55 converts first a pixel drive data bit into a pixel data pulse PD having a pulse voltage corresponding to a logical level thereof. For example, when a pixel drive data bit of a logical level of 1, which sets the discharge cell PC to light emitting mode, is supplied, the address driver 55 converts it into a pixel data pulse DP having a positive-polarity peak potential. On the other hand, the address driver 55 converts to a low-voltage (0 volt) pixel drive data pulse DP, a pixel drive data bit of a logical level of 0, which sets the discharge cell PC to non-light emitting mode. Further, the address driver 55 applies such pixel drive data pulse DP, display line by display line (number of m), to the column electrodes D₁-Dₘ, in synchronism with application timing of the respective write scanning pulses SPw. In this event, the selective write address discharge is generated between the column electrode D and row electrode Y in the discharge cell PC, to which high-voltage pixel data pulse DP to set to light emitting mode is applied, simultaneously with the aforementioned pixel data pulse DP is applied. With such selective write address discharge, the discharge cell PC is set to a state in which positive-polarity wall charge is formed near the row electrode Y, negative-polarity wall charge is formed near the row electrode X, and positive-polarity wall charge is near the column electrode D, respectively, i.e., to light emitting mode. On the other hand, between the column electrode D and row electrode X in the discharge cell PC, to which low-voltage (0 bolt) pixel data pulse DP to set to non-light emitting mode is applied, simultaneously with the aforementioned write scanning pulse SPw, such selective write address discharge as described above, is not generated, and therefore, no discharge is generated between the row electrodes X and Y. Because of this, the discharge cell PC maintains the state immediately theretofore, i.e., an initialized state of non-light emitting mode.

Next, in the sustain stage I in the sub-field SF1, the Y electrode driver 53 generates a sustain pulse IP having positive-polarity peak potential, only by one pulse, and applies it to the respective row electrodes X₁-Xₙ. During this time, the X electrode driver 51 sets the row electrodes X₁-Xₙ to a ground potential (0 volt), and the address driver 55 sets the column electrodes D₁-Dₘ to a ground potential (0 bolt). In correspondence with application of the aforementioned sustain pulse IP, sustain discharge is generated between the row electrodes X and Y in the discharge cell PC, which is set to light emitting mode, as described above. Light irradiated from the fluorescent material layer 17 in correspondence with such sustain discharge is irradiated to outside through the front transparent plate 10, and thereby, one portion of display lighting is made in correspondence with the luminance weight of the sub-field SF1. Then, after application of such sustain pulse IP, the Y electrode driver 53 applies to the row electrodes Y₁-Yₙ, a wall charge adjusting pulse CP having a negative-polarity peak potential of which potential transition is gradual with the lapse of time at the front edge, as shown in FIG. 17. In correspondence with such application of the wall charge adjusting pulse CP, weak erasure discharge is generated in the discharge cell PC in which the aforementioned sustain discharge is generated, and a portion of the wall charge formed in the inside is erased. Thereby, an amount of the wall charge in the discharge cell PC is adjusted to an amount which permits to adequately generate the selective erasure address discharge, in the succeeding selective erasure address stage W_{D}.

In the selective erasure address stage Wo in the respective sub-fields SF2-SF14, while the Y electrode driver 53 applies to the respective row electrodes Y₁-Yₙ, a base pulse BP+ having positive-polarity peak potential, it applies sequentially and alternatively to the row electrodes Y₁-Yₙ, an erasure scanning pulse SP_{D} having negative-polarity peak potential, as shown in FIG. 17. In this case, the potential of the base pulse BP⁺ is set to a potential permitting to prevent erroneous discharge between the row electrodes X and Y, during execution period of the selective erasure address stage W_{D}. Further, during the execution period of the selective erasure address stage W_{D}, the X electrode driver 51 sets the respective row electrodes X₁-Xₙ to a ground potential (0 volt). Further, in the selective erasure address W_{D}, the address driver 55 first converts a pixel drive data bit corresponding to the sub-field SF into a pixel data pulse DP having pulse voltage corresponding to a logical level thereof. For example, the address driver 55 converts the discharge cell PC into a pixel data pulse DP having positive-polarity potential, when a pixel drive data bit having a logical level of 1 for transition from light emitting mode to non-light emitting mode is supplied. On the other hand, when a pixel drive data bit having a logical level of 0, to maintain the current state of the discharge cell PC is supplied, the address driver 55 converts said bit into a low-voltage (0 bolt) pixel data pulse DP. Then, the address driver 55 converts such pixel data pulse DP, display line by display line (number of m), to the column electrodes D₁-Dₘ in synchronism with application timing of the respective erasure scanning pulses SP_{D}. In this event, between the column electrode D and row electrode Y in the discharge cell PC to which high-voltage, positive-polarity pixel data pulse DP is applied simultaneously with said erasure scanning pulse SP_{D}, selective erasure address discharge is generated. With such selective erasure discharge, the discharge cell PC is set to a state in which positive-polarity wall charge is formed near each of the row electrodes X and Y, and negative-polarity wall charge is formed near the column electrode D, respectively, i.e, to non-light emitting mode. On the other hand, between the column electrode D and row electrode Y in the discharge cell PC to which low-voltage (0 bolt) pixel data pulse DP simultaneously with the aforementioned erasure scanning pulse SP_{D}, the selective erasure address discharge is not generated. Therefore, the discharge cell PC maintains a state immediately theretofore (light emitting mode, non-light emitting mode).

Next, in the sustain stage I in each of the sub-fields SF2-SF14, as shown in FIG. 17, the X electrode driver 51 and Y electrode driver 53 repeat the stage by a frequency (even-numbered frequency) corresponding to the luminance weight of the sub-fields, alternately to the X and Y electrodes, and applies a sustain pulse IP having positive-polarity peak potential to the row electrodes X₁-Xₙ and Y₁ Yₙ, respectively. At each time when such sustain pulse IP is applied, sustain discharge is generated between the row electrodes X and Y in the discharge cell PC which is set to light emitting mode. By irradiation of light irradiated from the fluorescent material layer 17 through the front transparent plate 10, accompanied with such sustain discharge, display light emission is performed by a frequency corresponding to the luminance weight of the sub-fields SF. In this event, negative-polarity wall charge is formed near the row electrode Y and positive-polarity wall charge is formed near the row electrode X and column electrode D, respectively, in the discharge cell PC in which sustain discharge is generated in correspondence with the sustain pulse IP last applied in the sustain stage I in each of the sub-fields SF2-SF14. Further, after application of the last sustain pulse IP, as shown in FIG. 17, the Y electrode driver 53 applies to the row electrodes Y₁-Yₙ, a wall charge adjusting pulse CP having positive-polarity peak potential of which potential transition is gradual with the lapse of time at the front edge. With application of such wall charge adjusting pulse CP, weak erasure discharge is generated in the discharge cell PC in which the aforementioned sustain discharge is generated, and a portion of wall charge formed inside thereof is erased. Thereby, the amount of the wall charge in the discharge cell PC is adjusted to an amount permitting to adequately perform selective erasure address discharge in a succeeding selective erasure address stage W_{D}.

The aforementioned driving is executed according to 15 combinations of the pixel drive data GD, as shown in FIG. 15. With such driving, as shown in FIG. 15, except when representing a luminance level of 0 (first level of grayscale), first in the first sub-field SF1, write address discharge is generated in each of the discharge cells PC (marked with a double circle), and then the discharge cell PC is set to light emitting mode. Thereafter, selective erasure address discharge is generated only in the selective erasure address stage Wo in one of the sub-fields SF2-SF14 (marked with a black circle), and then the discharge cell PC is set to non-light emitting mode. In other words, each of the discharge cells PC is set to light emitting mode in each of the continuous sub-fields for a portion corresponding to a halftone luminance to represent, and light emission incidental to the sustain discharge is repeatedly generated by a frequency assigned to each of the sub-fields (marked with a white circle). At this time, luminance corresponding to a total number of sustain discharge generated in one field (or one frame) is viewed. Therefore, according to the light emission patterns by driving of the first to fifteenth levels of grayscale shown in FIG. 15, halftone luminance is made with respect to the 15 levels of grayscale which correspond to the total number of sustain discharge generated in each of the sub-fields marked with a white circle.

Further, in driving shown in FIGS. 15-17, in the first sub-field SF1, first, initialization to non-light emitting mode is made by performing reset discharge of all the discharge cells PC, and transition to light emitting mode is made by generating write address discharge (marked with a double circle) to each of the discharge cells PC, except when performing black display (first grayscale level). Further, when black display is made by such driving, discharge generated for one field display period is only reset discharge in the first sub-field SF 1. Therefore, compared with the use of the driving which generates selective erasure address discharge for shifting to non-light emitting mode, the frequency of discharge generated for one field display period decreases. Thereby, it is possible to improve a contrast when displaying dark image, so-called “dark contrast”.

Further, in a plasma display apparatus shown in FIG. 14, the probability of write address discharge in the sub-field SF1 is increased by the following forced lighting processing according to the forced lighting processing circuit 30.

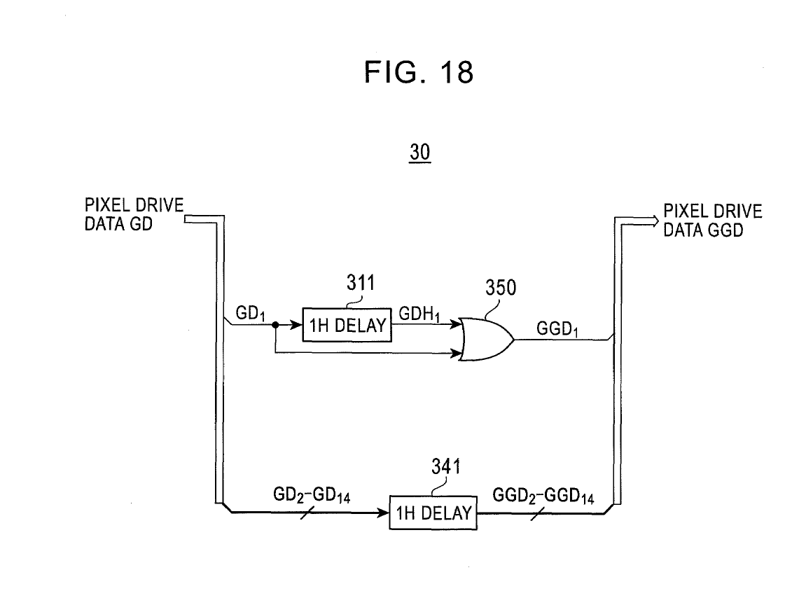

FIG. 18 is a diagram showing an example of the internal configuration of the forced lighting processing circuit 30.

As shown in FIG. 18, the forced lighting processing circuit 30 is comprised of a 1H delay circuits 311 and 341, and an OR gate 350.

The 1H delay circuit 311 supplies to the OR gate 350 as the delay first bit GDH1, the first bit (GD₁) in the pixel drive data GD supplied from the pixel drive data generator circuit 20, which is delayed by a period used to supply one display line (number of m) of the pixel drive data GD (hereinafter called “1H period”). The OR gate 350 outputs a result of the logical sum of such delayed bitGDH₁ and the first bit (GD₁) in the pixel drive data GD, as the first bit in the pixel drive data GGD. The 1H delay circuit 341 supplies to the OR gate as the delay second bit (GGD₂)-fourteenth bit (GGD₁₄), each of the second bit (GD₂)-fourteenth bit (GD₁₄) in the pixel drive data GD, which is delayed by said 1H period.

In other words, the forced lighting processing circuit 30 employs as the second bit-fourteenth bit of the pixel drive data GGD without changing the logical level for each bit, the second bit-fourteenth bit corresponding to the sub-fields SF-SF14, respectively comprising the selective erasure address stage W_{D}, in the first bit-fourteenth bit in the pixel drive data GD.

On the other hand, with respect to the first bit corresponding to the sub-field 1 comprising the selective write address stage Ww, the forced lighting processing circuit 30 determines a logical sum with a bit to be supplied after 1H period, and sets the result to be the first bit of the pixel drive data GGD. More specifically, with respect to the first bit in the pixel drive data GD, for each of the pixel drive data GD corresponding to each of the discharge cells, the logical sum is determined for each bit place, with the first bit of the pixel drive data GD corresponding to the discharge cells adjacent on the lower side of the discharge cell.

For example, when a logical level is 0 for the first bit of the pixel drive data GD corresponding to the first-row, first column discharge cell PC_{1,1} in the screen, and then if the logical level is 1 for the first bit of the pixel drive data GD corresponding to the second row, first column discharge cell PC_{2,1} adjacent thereunder, the logical sum of both, i.e., the logical level of 1 is obtained as the first bit of the pixel drive data GGD corresponding to the discharge cell PC_{1,1}. Further, when the first bit of the pixel drive data GD corresponding to the third row, first column discharge cell PC_{3,1} has a logical level of 0, and then when the first bit of the pixel drive data GD corresponding to the fourth row, first column discharge cell PC_{4,1} has a logical level of 0, a logical level of 0, which is the logical sum of both, is obtained as the first bit of the pixel drive data GGD corresponding to the discharge cell PC_{3,1}.

In other words, the forced lighting processing circuit 30 submits the first bit in the pixel drive data GD to the forced lighting processing which selects the logical level of 1, indicating the forced light emitting mode.

Here, when the first bit in the pixel drive data GGD has a logical level of 1, in the selective write address stage Ww in the sub-field SF1, write address discharge is generated between the column electrode D and row electrode Y in the discharge cell PC, and the discharge cell is set to light emitting mode.

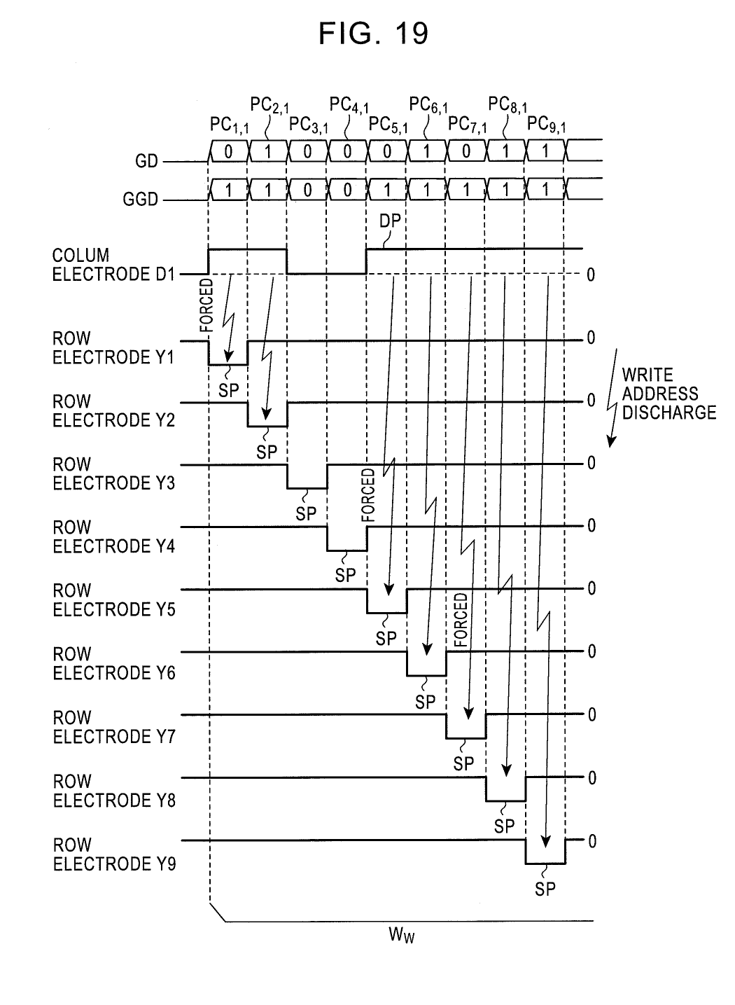

Below, such operation will be described with reference to an example shown in FIG. 19.

Here, FIG. 19 is a diagram showing the driving operation in each of the discharge cells PC_{1,1}-PC_{9,1}, performed in the selective write address stage Ww of the sub-field SF1, with the column electrode D₁ and row electrodes Y₁-Y₉ which are extracted from the PDP 50.

First, when the first bit in each of the pixel drive data GD corresponding to each of the discharge cells PC_{1,1}-PC_{9,1} is a bit series [0,1,0,0,0,1,0,1,1] in the pixel drive data GD corresponding to each of the discharge cells PC_{1,1}-PC_{9,1}, the forced lighting processing circuit 30 submits such bit series to the aforementioned forced lighting processing, and thereby obtains the pixel drive data GGD which has a bit series of the first bit of [1,1,0,0,1,1,1,1,1]. To each bit in the aforementioned bit series by the pixel drive data GGD, the address driver 55 sequentially applies to the column electrode D1, positive-polarity high voltage pixel data pulse D if the bit has a logical level of 1, and low voltage (0 bolt) pixel data pulse DP if the bit has a logical level of 0, as shown in FIG. 19. During this period, in synchronism with each of the pixel data pulses DP applied to each bit, as shown in FIG. 19, the Y electrode driver 53 applies sequentially and alternatively the negative-polarity scanning pulse SP from the row electrode Y₁ to Y₉. In this event, while a scanning pulse SP is applied, between the column electrode D₁ and row electrode Y in the discharge cell PC to which positive-polarity high voltage pixel data pulse DP is applied simultaneously, write discharge is generated, and the discharge cell PC is changed to the light emitting mode. Further, while the scanning pulse SP is applied, in the discharge cell PC to which low-voltage pixel data pulse DP is applied, the write address discharge as described above is not generated, and the discharge cell PC remains as it is immediately theretofore, i.e., in the non-light emitting mode state.

Here, with the pixel drive data GD having the bit series of [0,1,0,0,0,1,0,1,1], in the discharge cells PC_{2,1}, PC_{6,1}, PC_{8,1} and PC_{9,1}, which correspond to the bit of the logical level 1, as shown in FIG. 19, write address discharge is generated. In this event, in the discharge space of the discharge cell PC, electrically-charged particles are generated in correspondence with generation of various types of discharge, but the volume thereof decreases gradually with the lapse of time when the discharge stops, and the discharge probability drops. For example, as shown in FIG. 19, when the discharge cell is driven according to the pixel drive data GD, in the discharge cell PC_{9,1}, write address discharge is generated in the discharge cell PC_{8,1} adjacent thereto directly above, immediately before generation of the write address discharge. The electrically-charged particles generated by the discharge disperse in the discharge cell PC_{9,1} resulting in a volume of electrically-charged particles required for the discharge. By the electrically-charged particles, in the discharge cell PC_{9,1}, the generation probability of discharge is increased greatly, which permits to securely generate write address discharge. However, when a discharge cell is driven with the pixel drive data GD, in the discharge cell PC_{2,1} (or PC_{6,1}, PC_{9,1}), the write address discharge is not generated in the discharge cell PC1,1 (or PC_{5,1}, PC_{7,1}) adjacent directly above at the stage immediately before the write address discharge is generated, and therefore, the density of the electrically-charged particles is low. Therefore, in the discharge cell PC_{2,1} (or PC_{6,1}, PC_{9,1}) in comparison with the case of the aforementioned discharge cell PC_{9,1} the probability of generating the address discharge becomes lower.

In this regard, with respect to the discharge cells (PC_{1,1}, PC_{5,1}, PC_{7,1}, PC_{8,1}) adjacent directly on the upper side of the discharge cells (PC_{2,1}, PC_{6,1}, PC_{8,1}, PC_{9,1}) which generate write address discharge according to the pixel drive data GD, the write address discharge is made forcibly, regardless of the pixel drive data GD. In other words, as shown in FIG. 19, even when the logical level is 0, which indicates that the value of the pixel drive data GD signifies setting to non-light emitting mode, driving is executed with the pixel drive data GGD replacing the level with the logical level of 1, which indicates setting to light emitting mode. Thereby, when write address discharge is generated just in the discharge cells PC_{2,1}, PC_{6,1}, PC_{8,1} and PC_{9,1}, write address discharge is necessarily generated forcibly immediately theretofore also in the discharge cells PC_{1,1}, PC_{5,1}, PC_{7,1}, PC_{8,1} adjacent directly on the upper side thereof. Therefore, at a stage immediately before the write address discharge to each of the discharge cells PC_{2,1}, PC_{6,1} and PC_{8,1}, by the aforementioned discharge (write address discharge) generated forcibly, electrically-charged particles are obtained in an amount required to securely generate discharge, and the discharge probability is increased in each of the discharge cells PC_{2,1}, PC_{6,1} and PC_{8,1}. Further, there is a case that the write address discharge is not generated in some discharge cells which are forcibly set as a target of the write address discharge. In such case equally, by a voltage applied to generate such discharge, discharge probability increases in the discharge cells in which the write address discharge is generated intrinsically.

Thereby, as an amount of electrically-charged particles to be formed by reset discharge immediately before the selective write address stage Ww can be relatively small, the dark contrast can be improved by reducing or omitting the reset discharge.

Therefore, according to the aforementioned forced lighting processing, the dark contrast can be improved without reducing the discharge probability of write address discharge.

This application is based on Japanese Patent application No. 2007-168920 which is hereby incorporated by reference.

What is claimed is:

1. A plasma display panel driving method for driving a plasma display panel, in which a plurality of discharge cells serving as pixels are arranged in each of a plurality of display lines, and driven in a plurality of sub-fields that constitute each field of an input video signal, thereby to perform grayscale display, comprising:
an address stage of sequentially addressing said display lines line by line, and in each of the discharge cells belonging to the addressed display line respectively effecting a selective address discharge in accordance with pixel drive data, thereby setting the discharge cells to a state of either light emitting mode or non-light emitting mode, said pixel drive data being generated based on said input video signal and indicating whether an address discharge is to be effected or not in each of said discharge cells; and
a sustain stage of effecting a sustain discharge only in the discharge cells set to said light emitting mode to sustain discharge repeatedly times corresponding to the luminance weight of said sub-field; and
wherein in said address stage of a predetermined sub-field of said sub-fields, immediately before a display line to which belongs at least one display cell to effect the address discharge according to said pixel drive data, the address discharge is forcibly effected in a discharge cell arranged at a position adjacent to said one discharge cell among discharge cells belonging to a display line immediately before said display line to which said at least one display cell belongs.

2. A plasma display panel driving method according to claim 1, wherein in said address stage of said predetermined sub-field, the address discharge is forcibly effected in a discharge cell positioned adjacent to said one discharge cell on the upper side.

3. A plasma display panel driving method according to claim 1, wherein in said address stage of said predetermined sub-field, the address discharge is forcibly effected in a discharge cell positioned adjacent by two display lines upper than said one discharge cell.

4. A plasma display panel driving method according to claim 1, wherein forced address discharge is executed only in the discharge cells in which said sustain discharge is not generated at all in the immediately preceding field in the discharge cells belonging to the display line addressed immediately before the display line to which said one discharge cell belongs.

5. A plasma display panel driving method according to claim 1, said address stage comprising: setting said discharge cell to said light emitting mode by effecting a selective address discharge in accordance with said pixel drive data in each of said discharge cells, and setting to said light emitting mode by effecting the forced address in the discharge cell positioned adjacent to said one discharge cell among said discharge cells belongs to a display line immediately before said display line to which said one discharge cell belongs, regardless of said pixel drive data corresponding to the discharge cell,

6. A plasma display panel driving method according to claim 1, wherein said predetermined sub-field is either a head sub-field or at least two sub-fields placed consecutively from said head sub-field in one field period.

7. A plasma display panel driving method according to claim 6, wherein said first sub-field is minimal in terms of luminance weight in each of said sub-fields, and said address stage of said first sub-field or each of said two sub-fields sets said discharge cell to said light emitting mode by effecting the write address discharge said discharge cell.

8. A plasma display panel driving method according to claim 1, wherein said sustain discharge is generated in the sustain stage of each of consecutive sub-fields from said first sub-field the number of which corresponds to a luminance level according to said input video signal.

9. A plasma display panel driving method according to claim 2, wherein said sustain discharge is generated in the sustain stage of each of consecutive sub-fields from said first sub-field the number of which corresponds to a luminance level according to said input video signal.

10. A plasma display panel driving method according to claim 3, wherein said sustain discharge is generated in the sustain stage of each of consecutive sub-fields from said first sub-field the number of which corresponds to a luminance level according to said input video signal.

11. A plasma display panel driving method according to claim 4, wherein said sustain discharge is generated in the sustain stage of each of consecutive sub-fields from said first sub-field the number of which corresponds to a luminance level according to said input video signal.

12. A plasma display panel driving method according to claim 5, wherein said sustain discharge is generated in the sustain stage of each of consecutive sub-fields from said first sub-field the number of which corresponds to a luminance level according to said input video signal.

13. A plasma display panel driving method according to claim 6, wherein said sustain discharge is generated in the sustain stage of each of consecutive sub-fields from said first sub-field the number of which corresponds to a luminance level according to said input video signal.

14. A plasma display panel driving method according to claim 7, wherein said sustain discharge is generated in the sustain stage of each of consecutive sub-fields from said first sub-field the number of which corresponds to a luminance level according to said input video signal.
